(19) United States
(12) Patent Application Publication
(10) Pub. No.: US 2024/0196274 A1
(43) Pub. Date: Jun. 13, 2024

(54) Methods for Mobility Setting Adjustment based on Predictions

(71) Applicant: Telefonaktiebolaget LM Ericsson (publ), Stockholm (SE)

(72) Inventors: Luca Lunardi, Genoa (IT); Pablo Soldati, Solna (SE); Henrik Rydén, Stockholm (SE); Reem Karaki, Aachen (DE); Angelo Centonza, Granada (ES)

(21) Appl. No.: 18/554,535

(22) PCT Filed: Apr. 27, 2022
(86) PCT No.: PCT/EP2022/061202

§ 371 Date: Oct. 9, 2023

Related U.S. Application Data
(60) Provisional application No. 63/182,139, filed on Apr. 30, 2021.

(51) Int. Cl. H04W 28/08; H04W 8/02; H04W 24/02; H04W 36/22

(52) U.S. Cl. CPC H04W 28/0942; H04W 8/02; H04W 24/02; H04W 36/22

(57) ABSTRACT

Embodiments include methods for a first network node of a wireless network. Such methods include sending, to a second network node in the wireless network, a first message comprising an indication of predicted future adjustments of mobility-related settings, of the first network node, for mobility of users between a coverage area of the first network node and an adjacent coverage area of the second network node. Such methods include receiving, from the second network node in response to the first message, a second message indicating one or more of the following: acknowledgement, confirmation, or rejection of the predicted future adjustments; and corresponding adjustments of mobility-related settings for the second network node. Other embodiments include complementary methods for a second network node and a third network node, as well as network nodes configured to perform such methods.

### TECHNICAL FIELD

The present disclosure relates generally to wireless networks, and more specifically to techniques for improved mobility of user equipment (UEs) between cells of a wireless network based on predictions of future changes in load, traffic, and/or resource utilization in the wireless network.

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region,” which is defined in 3GPP TS 23.501 (v16.8.0). If security protection for CP and UP data on TNL of NG-RAN interfaces is supported, NDS/IP shall be applied.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Self-optimization is a process in which UE and network measurements are used to auto-tune the RAN. This occurs when RAN nodes are in an operational state, which generally refers to the time after the node's RF transmitter interface is switched on. Self-configuration operations include optimization and adaptation, which are generally performed before the RAN nodes are in operational state.

Self-configuration and self-optimization features for NR networks are described in 3GPP TS 38.300 (v16.5.0) section 15 and for earlier-generation Long-Term Evolution (LTE) networks in 3GPP TS 36.300 (v16.5.0) section 22.2. These features include dynamic configuration, automatic neighbor relations (ANR), mobility load balancing (MLB), mobility robustness optimization (MRO), random access channel (RACH) optimization, capacity and coverage optimization (CCO), and mobility settings change.

MLB involves coordination between two or more network nodes to optimize the traffic loads of their respective cells, thereby enabling a better use of radio resources available in a geographic area among served UEs. MLB can involve load-based handover of UEs between cells served by different nodes, thereby achieving “load balancing”.

CCO involves coordination between two or more network nodes to optimize the coverage and capacity offered by their respective cells. For example, a reduced coverage and/or capacity in a cell served by a first network node can be compensated by an increase in the coverage and/or capacity of neighboring cell served by a second network node.

Mobility settings change involves two network node negotiating a mutually-agreeable value for a parameter that triggers UE handover (or other mobility operation) between neighbor cells. This parameter effectively defines a “virtual cell border” experienced by UEs based on their measurements and/or assessments, e.g., of quality and/or strength of reference signals received from the respective cells. For example, a setting change for a handover trigger parameter can expand or shrink the UE's observed coverage area of a serving cell, thereby causing the UE to request a handover to a neighbor cell having a higher measured signal strength and/or quality.

### SUMMARY

Even so, current approaches used for these and other self-configuration/self-optimization features are reactive based on current network conditions and/or current UE traffic load. In other words, the current approaches adjust coverage, capacity, load, etc. in response to inputs indicating onset of a degradation in network performance, e.g., due to increased interference, resource utilization, user traffic, etc. However, there can be significant delays between the adjustments and their desired effects, during which the degradation in network performance will continue.

Embodiments of the present disclosure provide specific improvements to communication between UEs and network nodes in a wireless network, such as by providing, enabling, and/or facilitating solutions to overcome exemplary problems summarized above and described in more detail below.

Embodiments include methods (e.g., procedures) for a first network node (e.g., base station, eNB, gNB, ng-eNB, etc.) of a wireless network (e.g., E-UTRAN, NG-RAN).

These exemplary methods can include sending, to a second network node in the wireless network, a first message comprising an indication of predicted future adjustments of mobility-related settings, of the first network node, for mobility of users between a coverage area of the first network node and an adjacent coverage area of a second network node of the wireless network. These exemplary methods can also include receiving, from the second network node in response to the first message, a second message indicating one or more of the following:
acknowledgement, confirmation, or rejection of the predicted future adjustments; and
corresponding adjustments (e.g., proposed or actual) of mobility-related settings for the second network node.

In some of embodiments, these exemplary methods can also include determining the predicted future adjustments of mobility-related settings of the first network node based on one or more of the following:
measured load and/or traffic during one or more current and/or previous time periods for one or more of the following: one or more cells served by the first network node, one or more cells served by the second network node, one or more beams served by the first network node, and one or more beams served by the second network node,
predicted load and/or traffic during one or more subsequent time periods for one or more of the following: the one or more cells served by the first network node, the one or more cells served by the second network node, the one or more beams served by the first network node, and the one or more beams served by the second network node;
accuracy, precision, validity, reliability, stability, and/or likelihood associated with the predicted load and/or traffic;
measurements made by one or more UEs on one or more of the following: the one or more cells served by the first network node, the one or more cells served by the second network node, the one or more beams served by the first network node, and/or the one or more beams served by the second network node; and
current and/or predicted future radio-related conditions in the wireless network.

In some embodiments, the first message can also include one or more of the following:
an identifier associated with the predicted future adjustments;
an indication of accuracy, precision, validity, reliability, stability, and/or likelihood associated with the predicted future adjustments or with information used by the first network node to determine the predicted future adjustments;
an indication of load and/or traffic that is expected to be transferred from the first network node to the second network node after the predicted future adjustments are applied;
an indication of load and/or traffic that is expected to be transferred from the first network node to the second network node before the predicted future adjustments are applied; and
an indication of a validity time for the predicted future adjustments.

In some embodiments, the indication of the predicted future adjustments can include an indication of one or more of the following:
that the predicted future adjustments will be applied by the first network node based on one or more first conditions;
that the predicted future adjustments will not be applied by the first network node based on one or more second conditions; and
that corresponding adjustments of mobility-related settings should be made by the second network node for mobility of users between the coverage area of the second network node and the adjacent coverage area of the first network node.

In some of these embodiments, when the first message indicates that corresponding adjustments of mobility-related settings should be made by the second network node, the second message also indicates one or more of the following:
confirmation or rejection of the corresponding adjustments indicated in the first message; and
the corresponding adjustments, which are different than the corresponding adjustments indicated in the first message.

In some of these embodiments, one or more of the following applies:
when the second message includes a rejection of the predicted future adjustments indicated in the first message, the second message also includes a cause value indicating a reason why the predicted future adjustments are rejected by the second network node; and
when the second message includes a rejection of the corresponding adjustments indicated in the first message, the second message also includes a cause value indicating a reason why the corresponding adjustments are rejected by the second network node.

In some of these embodiments, the mobility-related settings for the first network node include a first mobility trigger point, and a coverage area of the first network node corresponds to a difference between a previous or current value of the first mobility trigger point and an adjusted value of the first mobility trigger point. In such embodiments, the one or more first conditions can include any of the following:
load and/or load variation in the coverage area of the first network node being above, below, or between one or more first thresholds; and
a first time when or after which the predicted future adjustments will be applied, with the first time being indicated in the first message.

In such embodiments, the one or more second conditions include any of the following:
load and/or load variation in the coverage area of the first network node being above, below, or between one or more second thresholds; and
a second time when or after which the predicted future adjustments have not been or will not be applied, the second time being indicated in the first message.

In some embodiments, the mobility-related settings for the second network node include a second mobility trigger point and a coverage area of the second network node corresponds to a difference between a previous or current value of the second mobility trigger point and an adjusted value of the second mobility trigger point. In such embodiments, the corresponding adjustments of mobility-related settings (i.e., indicated in the second message) are based on one or more of the following third conditions:
load and/or load variation in the coverage area of the second network node being above, below, or between one or more third thresholds; and
the first time.

In some embodiments, the predicted future adjustments indicated in the first message and the corresponding adjustments indicated in the second message can include at least one of the following:
adjustments to one or more of the following mobility-related settings: trigger points, hysteresis, time to trigger, and measurement offsets; and
adjustments specific to one or more of the following: one or more cells, one or more SSB beams, one or more CSI-RS beams, one or more network slices, one or more carrier frequencies, one or more services, one or more public land mobile networks (PLMNs), and one or more UEs.

In some embodiments, the second message can also include one or more of the following:
an identifier associated with the corresponding adjustments;
one or more limitations at the second network node with respect to the predicted future adjustments of the first network node and/or the corresponding adjustments of the second network node indicated in the first message (e.g., minimum and/or maximum limit for adjustments of mobility settings);
actual or estimated amount of traffic and/or load to be transferred from second network node to first network node after one or more of the following:
   the predicted future adjustments indicated in the first message are applied by the first network node;
   the corresponding adjustments indicated in the first message are applied by the second network node; and
   the corresponding adjustments indicated in the second message are applied by the second network node.

In some embodiments, these exemplary methods can also include sending, to the second network node, a third message indicating whether or not the predicted future adjustments indicated by the first message have been or will be applied. In some embodiments, these exemplary methods can also include receiving, from a third network node in the wireless network, a fourth message including a request for predicted future adjustments of mobility-related settings, of the first network node, for mobility of users between the coverage area of the first network node and the adjacent coverage area of the second network node. In some of these embodiments, these exemplary methods can also include sending, to the third network node in response to the fourth message, a fifth message including one or more of the following:
the predicted future adjustments of mobility-related settings of the first network node;
the corresponding adjustments of mobility related settings of the second network node;
an indication of whether the second network node has acknowledged, rejected, or confirmed the predicted future adjustments and/or the corresponding adjustments;
an indication that the predicted future adjustments have been or will be applied by the first network node; and
a time of application for the predicted future adjustments.

Other embodiments include exemplary methods (e.g., procedures) for a second network node (e.g., base station, eNB, gNB, ng-eNB, etc.) of a wireless network (e.g., E-UTRAN, NG-RAN). In general, these exemplary methods can be complementary to the exemplary methods for a first network node summarized above.

These exemplary methods can include receiving, from the first network node, a first message comprising an indication of predicted future adjustments of mobility-related settings, of the first network node, for mobility of users between a coverage area of the first network node and an adjacent coverage area of the second network node. These exemplary methods can also include sending, to the first network node in response to the first message, a second message indicating one or more of the following:
acknowledgement, confirmation, or rejection of the predicted future adjustments; and
corresponding adjustments (e.g., proposed or actual) of mobility-related settings for the second network node.

In some embodiments, these exemplary methods can also include determining the corresponding adjustments of mobility-related settings of the second network node, indicated in the second message, based on one or more of the following:
the predicted future adjustments of mobility-related settings of the first network node, indicated in the first message;
measured load and/or traffic during one or more current and/or previous time periods for one or more of the following: one or more cells served by the first network node, one or more cells served by the second network node, one or more beams served by the first network node, and one or more beams served by the second network node,
predicted load and/or traffic during one or more subsequent time periods for one or more of the following: the one or more cells served by the first network node, the one or more cells served by the second network node, the one or more beams served by the first network node, and the one or more beams served by the second network node;
accuracy, precision, validity, reliability, stability, and/or likelihood associated with the predicted load and/or traffic;
measurements made by one or more UEs on one or more of the following: the one or more cells served by the first network node, the one or more cells served by the second network node, the one or more beams served by the first network node, and/or the one or more beams served by the second network node; and
current and/or predicted future radio-related conditions in the wireless network, such as examples such as changes in interference, addition/removal of neighbor cells, changes in cell boundaries, changes in frequencies used, changes in radio propagation obstructions such as walls, buildings, etc.

In some embodiments, the indication of the predicted future adjustments can include an indication of one or more of the following:
that the predicted future adjustments will be implemented by the first network node based on one or more first conditions;
that the predicted future adjustments will not be implemented by the first network node based on one or more second conditions; and
that corresponding adjustments of mobility-related settings should be made by the second network node for mobility of users between the coverage area of the second network node and the adjacent coverage area of the first network node.

In various embodiments, the predicted adjustments, the corresponding adjustments, the first conditions, the second conditions, etc. can include any of the corresponding features summarized above for the first network node embodiments. In various embodiments, the first message can also include any of the additional information summarized above for the first network node embodiments. In various embodiments, the second message can also include any of the additional information summarized above for the first network node embodiments.

In some embodiments, these exemplary methods can also include receiving, from the first network node, a third message indicating whether or not the predicted future adjustments indicated by the first message have been or will be applied.

Other embodiments include exemplary methods (e.g., procedures) for a third network node (e.g., base station, eNB, gNB, ng-eNB, etc.) of a wireless network (e.g., E-UTRAN, NG-RAN). In general, these exemplary methods can be complementary to the exemplary methods for the first and second network nodes summarized above.

These exemplary methods can include sending, to a first network node in the wireless network, a fourth message including a request for predicted future adjustments of mobility-related settings, of the first network node, for mobility of users between the coverage area of the first network node and the adjacent coverage area of a second network node of the wireless network. These exemplary methods can also include receiving, from the first network node in response to the fourth message, a fifth message including an indication of the requested predicted future adjustments.

In some embodiments, the fifth message can also include one or more of the following:
corresponding adjustments (e.g., proposed or actual) of mobility related settings of the second network node;
an indication of whether the second network node has acknowledged, rejected, or confirmed the predicted future adjustments and/or the corresponding adjustments;
an indication that the predicted future adjustments have been or will be applied by the first network node; and
a time of application for the predicted future adjustments.

In some embodiments, the predicted future adjustments indicated in the fifth message and the corresponding adjustments indicated in the fifth message can include at least one of the following:
adjustments to one or more of the following mobility-related settings: trigger points, hysteresis, time to trigger, and measurement offsets; and
adjustments specific to one or more of the following: one or more cells, one or more SSB beams, one or more CSI-RS beams, one or more network slices, one or more carrier frequencies, one or more services, one or more PLMNs, and one or more UEs.

In some embodiments, the fifth message can also include one or more of the following:
an identifier associated with the predicted future adjustments;
an indication of accuracy, precision, validity, reliability, stability, and/or likelihood associated with the predicted future adjustments or with information used by the first network node to determine the predicted future adjustments;
an indication of load and/or traffic that is expected to be transferred from the first network node to the second network node after the predicted future adjustments are applied;
an indication of load and/or traffic that is expected to be transferred from the first network node to the second network node before the predicted future adjustments are applied; and
an indication of a validity time for the predicted future adjustments.

Other embodiments include network nodes (e.g., base stations, eNBs, gNBs, ng-eNBs, etc.) configured to perform operations corresponding to any of the exemplary methods described herein. Other embodiments include non-transitory, computer-readable media storing program instructions that, when executed by processing circuitry, configure such network nodes to perform operations corresponding to any of the exemplary methods described herein.

Embodiments described herein can enable a network node to cope with predicted changes to traffic or load, such as peaks of load or interference localized at the edges of its cells (or portions thereof, such as beams) that border other cells (or portions thereof) served by a different network node. For example, handover trigger points can be temporarily adjusted to address such predicted traffic or load, which can reduce, prevent, attenuate, and/or eliminate performance degradations such as reduced user data throughput and UE connections to the network being dropped and/or lost. Furthermore, receiving information about predicted mobility-related adjustments by a first network node can facilitate a second network node to proactively handover one or more UEs to the first network node, which can counteract potential and/or expected handover of traffic from the first network node to the second network node based on the predicted mobility-related adjustments by the first network node.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIGS. 4A-4B show signal flows for procedures related to resource status reporting between nodes in an NG-RAN.

FIGS. 5A-5B show signal flows for procedures related to mobility settings change between nodes in an NG-RAN.

FIG. 6 shows signal flows between a first network node, a second network node, and a third network node, according to various embodiments of the present disclosure.

FIG. 7 shows a flow diagram of an exemplary method for a first network node (e.g., base station, eNB, gNB, ng-eNB, etc.), according to various embodiments of the present disclosure.

FIG. 8 shows a flow diagram of an exemplary method for a second network node (e.g., base station, eNB, gNB, ng-eNB, etc.), according to various embodiments of the present disclosure.

FIG. 9 shows a flow diagram of an exemplary method for a third network node (e.g., base station, eNB, gNB, ng-eNB, etc.), according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in functions implemented by some embodiments of the present disclosure may be virtualized.

FIG. 15 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio access node, transmission point (TP), transmission reception point (TRP), remote radio head (RRH), remote radio unit (RRU), Distributed Antenna System (DAS), relay, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

As briefly mentioned above, current approaches used for LTE and NR self-configuration/self-optimization features are reactive based on current network conditions and/or current UE traffic load. In other words, the current approaches adjust coverage, capacity, load, etc. in response to inputs indicating onset of a degradation in network performance, e.g., due to increased interference, resource utilization, user traffic, etc. However, there can be significant delays between the adjustments and their desired effects, during which the degradation in network performance will continue. This is discussed in more detail below after the following description of NR network architecture and protocols.

FIG. 2 shows a high-level view of an exemplary 5G network architecture, including NG-RAN 299 and 5GC 298. As shown in the figure, NG-RAN 299 can include gNBs (e.g., 210a,b) and ng-eNBs (e.g., 220a,b) that are interconnected via respective Xn interfaces. The gNBs and ng-eNBs are also connected via NG interfaces to 5GC 298, more specifically to the Access and Mobility Management Functions (AMFs e.g., 230a,b) via respective NG-C interfaces and to User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., 260a,b).

Each of the gNBs 210 can support the NR radio interface including frequency division duplexing (FDD), time division duplexing (TDD), or a combination thereof. Each of ng-eNBs 220 can support the LTE radio interface. Unlike conventional LTE eNBs, however, ng-eNBs 220 connect to the 5GC via the NG interface. Each of the gNBs and ng-eNBs can serve a geographic coverage area including one more cells, such as exemplary cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is also possible that a single NG-RAN node provides both types of functionality. 5G/NR technology shares many similarities with LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, rather than a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

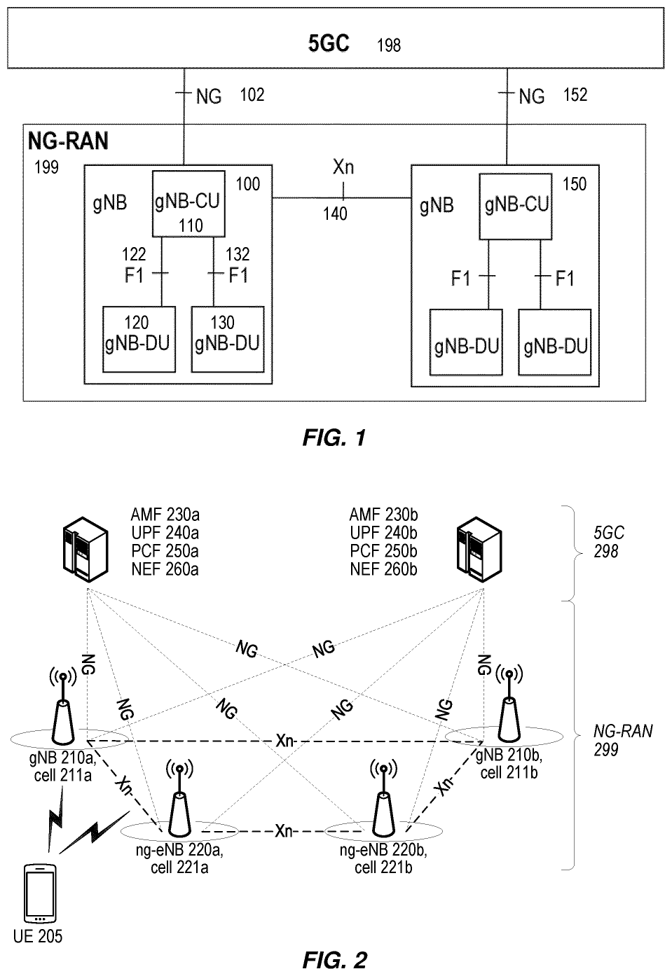

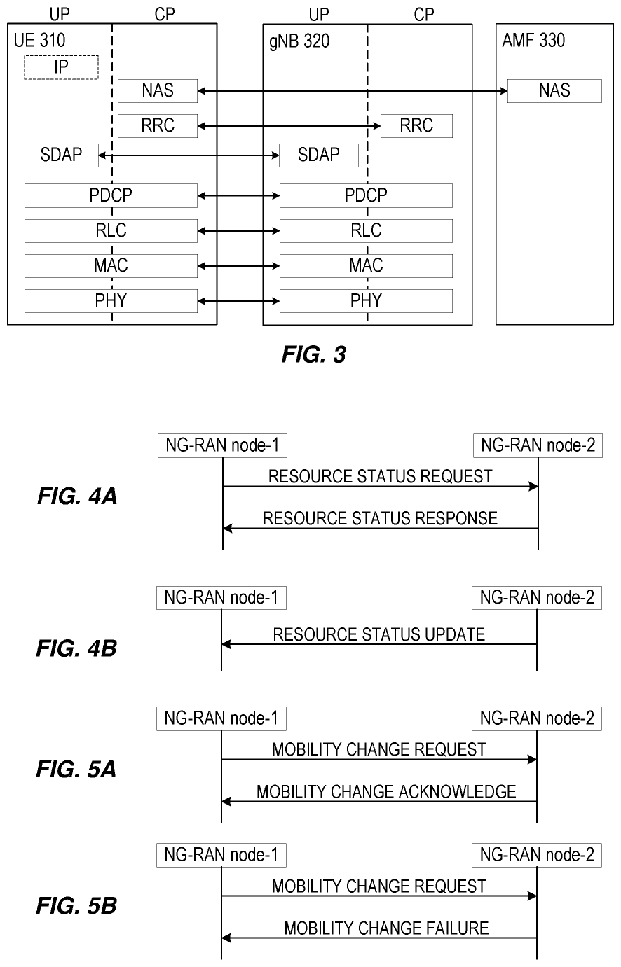

FIG. 3 shows an exemplary configuration of NR user plane (UP) and control plane (CP) protocol stacks between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NP UE in PRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

The gNB-CUs shown in FIG. 1 can be further divided into two logical entities: gNB-CU-UP, which serves the UP and hosts PDCP; and gNB-CU-CP, which serves the CP and hosts PDCP and RRC layers. In addition, gNB-DUs hosts RLC, MAC, and PHY layers.

A RAN node can exploit several types of information for operations such as mobility load balancing (MLB), mobility robustness optimization (MRO), capacity and coverage optimization (CCO), and mobility settings change. One information source is resource status information exchanged between RAN nodes using a “Resource Status Reporting” procedure. This procedure is performed over the X2AP (for LTE E-UTRAN) or XnAP (for NG-RAN) interfaces, whereby one RAN node sends a Resource Status Update message to another RAN node. Other relevant procedures include Resource Status Reporting Initiation (for both E-UTRAN and NG-RAN), EN-DC Resource Status Reporting Initiation (for E-UTRAN only), and EN-DC Resource Status Reporting (for E-UTRAN only). These are further defined in the X2AP and XnAP specifications, respectively 3GPP TS 36.423 (v16.5.0) and 3GPP TS 38.423 (v16.5.0).

FIG. 4A shows an exemplary Resource Status Reporting Initiation procedure between two NG-RAN nodes (e.g., gNBs or ng-eNBs) over XnAP. In this procedure, a first NG-RAN node can request a one-time or periodic reporting of load measurements by a second NG-RAN node. The first NG-RAN node initiates the procedure by sending the RESOURCE STATUS REQUEST message to the second NG-RAN node to start, stop or add cells to report for a measurement. The RESOURCE STATUS REQUEST message indicates the type of load metrics the second NG-RAN node shall measure. Depending on the preceding request, the RESOURCE STATUS UPDATE message by the second NG-RAN node can include one of more of the following:
Load information on a per SSB coverage area granularity, such as radio resource status per SSB coverage area, composite available capacity per SSB coverage area, etc.
Load information on a per network slice granularity, such as slice available capacity per network slice.
Load information on a per cell granularity, such as TNL capacity indication, number of active UEs, number of RRC connections, etc.

After a successful Resource Status Reporting Initiation procedure, the second NG-RAN node reports the results of the agreed-upon information once or periodically via the Resource Status Reporting procedure. FIG. 4B shows an exemplary Resource Status Reporting procedure between two NG-RAN nodes (e.g., gNBs or ng-eNBs) over XnAP. The second NG-RAN node uses the RESOURCE STATUS UPDATE message for the reporting.

CCO is an important building block of self-organizing networks (SON) for both LTE and NR. In general, CCO attempts to provide a required network capacity in a particular coverage area while minimizing interference and maintaining an acceptable quality of service (QoS) to users. Standardization of NR CCO is ongoing, with the LTE CCO solution used as a baseline. 3GPP TR 37.816 (v16.0.0) discusses various use cases for NR CCO but classifies them into two more generic scenarios of coverage problems and capacity problems.

The first involves scenarios in which reference signal (RS) coverage is sub-optimal, leaving UEs exposed to failures or degraded performance. Examples include coverage holes and UL/DL disparities. While MRO is intended to address all types of failures due to incorrect mobility settings within a network with good coverage, CCO is intended address scenarios having a root cause of poor coverage planning.

The second involves scenarios in which capacity within a cell or beam is saturated, resulting in one or more UEs being subject to failures or suboptimal performance. There are a number of reasons for such problems, including demand exceeding resources available in the cell/beam and poor radio conditions affecting a large portion of UEs served by the cell/beam. For example, when a large number of UEs are at or near a cell edge, they will consume a larger amount of resources per-UE and their increased transmission power will interfere with other UEs.

MLB is intended to address load distribution via mobility and is done mainly in inter-frequency scenarios, where cross-cell interference is not an issue. In contrast, CCO is intended to address scenarios having a root cause of UE concentration at an “edge” between cells or beams that use the same resources.

In general, CCO solutions adapt cell/beam coverage to achieve better system performance. They generally include two components: detection of a coverage and/or capacity issue, and action to resolve the issue. Information used by a CCO solution to detect coverage and capacity issues can include:
Per source cell/beam RS measurements from UEs
Per target(s) beam/cell RS measurement from UEs
Information on failure events associated with source and target cells, such as UE measurements on source and target reference signals (e.g., SSBs) at the time of failure, which can be included in UE radio link failure (RLF) reports;
Information about RACH access;
Interference measurements on a per UE basis; and
Cell load and other performance information from the target cell and the neighbor cells: this information enables the CCO function to determine relative capacity situation between the target and the neighbor cells and identify potential candidate cells for coverage and capacity coordination.

As briefly mentioned above, mobility settings change involves two network node negotiating a mutually-agreeable value for a parameter that triggers UE handover (or other mobility operation) between neighbor cells. This parameter effectively defines a “virtual cell border” experienced by UEs based on their measurements and/or assessments, e.g., of quality and/or strength of reference signals received from the respective cells. Mobility setting change procedures use UE-associated signaling.

FIG. 5A shows an exemplary signal flow for a successful Mobility Setting Change procedure between two NG-RAN nodes (e.g., gNBs or ng-eNBs) over XnAP. In this procedure, a first NG-RAN node initiates the procedure by sending a MOBILITY CHANGE REQUEST message to a second NG-RAN node, with the message including a proposed modification to a handover trigger parameter. Upon receipt, the second NG-RAN node evaluates whether the proposed handover trigger modification is acceptable. In the case shown in FIG. 5A, the second NG-RAN node determines that the proposed handover trigger modification is acceptable and replies with MOBILITY CHANGE ACKNOWLEDGE message.

FIG. 5B shows an exemplary signal flow for an unsuccessful Mobility Setting Change procedure between two NG-RAN nodes (e.g., gNBs or ng-eNBs) over XnAP. In this scenario, the proposed parameter modification is not acceptable to the second NG-RAN node or the second NG-RAN node is not able to complete the procedure. As such, the second NG-RAN node sends a MOBILITY CHANGE FAILURE message with a Cause information element (IE) set to an appropriate value. Optionally, the second NG-RAN node can include a Mobility Parameters Modification Range IE in the MOBILITY CHANGE FAILURE message, such as when the proposed modification is out of a permitted range.

Currently two RAN nodes serving neighboring coverage areas can adjust trigger points for UE handovers between cells based on measured traffic, but no automation is possible with respect to future traffic. This can result in peaks of load and/or interference, localized at the borders between coverage areas served by the two RAN nodes. Even if these are only for limited periods of time, surges in interference or resource utilization can cause degradation in performance, e.g., in terms of lower user data throughput and a higher incidence or rate of UE connections to the network that are dropped and/or lost.

Currently mobility settings changes occur in a reactive way, after actual performance degradation due to unbalanced or sub-optimal distribution of UEs has occurred and been detected by the RAN node(s). Currently, there is no mechanism to adjust the mobility settings (e.g., perceived cell borders) based on predictions on future traffic and/or load in cells (or portions thereof, such as beams) that border each other but are served by different RAN nodes.

Accordingly, embodiments of the present disclosure provide flexible and efficient techniques by which mobility-related settings (e.g., handover trigger points) associated with adjacent coverage areas (e.g., cells or portions thereof, such as SSB beams or CSI-RS beams) served by different network nodes can be adjusted based on predictions and/or measurements of load and/or traffic (also referred to as “predicted load and/or traffic” and “measured load and/or traffic”). Furthermore, the mobility-related settings adjusted based on predicted load and/or traffic and/or measured load and/or traffic may be associated with an entire coverage area (e.g., specific to a cell or more than one cell) or to a portion of the coverage area (e.g., specific to one or more SSB beams or CSI-RS beams within a cell).

In some embodiments, a first network node can send to a second network node a first message indicating predicted future adjustments of mobility-related settings of the first network node. The first network node can also indicate in the first message (e.g., as a request or a command) that second network node should adjust mobility-related parameters of the second network node, with the requested adjustments optionally included in the first message.

In some embodiments, the first message can include conditions under which the predicted future adjustments will be applied by the first network node, such as one or more of the following:
load and/or load variation (e.g., increase or decrease) in a coverage area defined between a previous or current mobility trigger point and an adjusted mobility trigger point, up to or above or below a given load threshold. “Load” can be measured and/or specified in terms of metrics signaled in a Resource Status Update message.
at a particular time, e.g., expiration of a defined timer or after a certain duration.

In some embodiments, the first message can include an indication of the amount of traffic and/or load that may be transferred from first network node to second network node in case the predicted future adjustments are applied by the first network node.

In some embodiments, the first network node can receive a second message from the second network node in response to the first mobility adjustment message. The second message can include at least one of the following:
an acknowledgement of the first message;
actual or predicted mobility-related adjustments by the second network node in response to the predicted future adjustments of mobility-related settings of the first network node, indicated in the first message;
a confirmation of predicted future adjustments of mobility-related settings of the first network node included in the first message;
a confirmation of requested adjustments of mobility-related parameters of the second network node included in the first message;
indication of failure or rejection of requested adjustments of mobility-related parameters of the second network node included in the first message, optionally including a cause for the failure or rejection;
indication of rejection of predicted future adjustments of mobility-related settings of the first network node included in the first message, optionally including a cause for the rejection;
one or more limitations at the second network node (e.g., an indication of overload),
an indication of the amount of traffic and/or load that may be transferred from second network node to first network node in case the predicted future adjustments of mobility-related settings are actually applied by the first network node.

In some embodiments, the first network node may send a third message to notify the second network node that the predicted future adjustments of mobility-related settings of the first network node, indicated by the first message, have been or will be applied. Alternately, the third message can indicate that the predicted future adjustments of mobility-related settings of the first network node will not be applied. For example, this latter case can occur if conditions that were as basis for the predicted future adjustments did not occur and/or materialize, or if information received form the second network node in the second message (e.g., amount of traffic and/or load that may be transferred from second network node to first network node) created conditions that made the predicted future adjustments impossible, unfeasible, impractical, and/or unnecessary.

In some embodiments, a third network node may be interested in mobility-related coordination between the first network node and the second network node based on predicted future adjustments. In such embodiments, the third network node can send a fourth message requesting the first network node to send to the third network node information concerning such mobility-related coordination between the first network node and the second network.

In some embodiments, the first network node can send a fifth message to inform a third network node about mobility-related coordination between the first network node and the second network node based on predicted future adjustments. This message can be unsolicited by the third network node, or it can be sent in response to the fourth message from the third network node.

Embodiments of the present disclosure can provide various advantages, benefits, and/or solutions to problems. For example, embodiments provide automated procedures to cope with predicted changes to traffic or load, such as peaks of load or interference localized at the edges of cells (or portions thereof, such as beams) that border each other but are served by different RAN nodes. As a more specific example, handover trigger points can be temporarily adjusted to address such predicted traffic or load, which can reduce, prevent, attenuate, and/or eliminate degradations in performance such as lower user data throughput and a higher incidence or rate of UE connections to the network being dropped and/or lost.

Furthermore, since a mobility-related adjustment related to a first network node's coverage area can affect handover boundaries to an adjacent coverage area of a second node, receiving information about predicted mobility-related adjustments by the first network node can facilitate the second node to proactively handover one or more UEs from to the first network node. This strategy can be used to counteract potential and/or expected handover of traffic from the first network node to the second network node based on the predicted mobility-related adjustments by the first network node.

In the following description, the term “message” is used generically to refer to any type of structured information carrier used by a first entity to send information to a second entity. Specific examples include messages or information elements (IEs) defined (or to be defined) in 3GPP specifications for existing or newly-defined interfaces, architectures, and/or protocol layers (e.g., RRC, MAC, Xn, F1AP, etc.).

Additionally, “message” is often herein used together with a numerical modifier, e.g., “first message, “second message”, etc. The numerical modifiers do not imply a strict temporal ordering of such messages, unless explicitly stated otherwise. Rather, they are used to distinguish between different messages having different content.

Furthermore, a first entity receiving a message “from” a second entity does not foreclose the possibility that the message travels on a path through one or more intermediate entities. Likewise, a first entity transmitting a message “to” a second entity does not foreclose the possibility that the message travels on a path through one or more intermediate entities.

For example, in some cases a “message” may be sent/received via direct XnAP or X2AP signaling connection between two network nodes. As an alternative example, a “message” may be sent/received through a core network (CN), via direct NGAP or S1AP signaling connections between the respective network nodes and the CN. Furthermore, a “message” can be sent/receive by two network nodes that serve cells using the same Radio Access Technology (RAT), or by two network nodes that serve cells using different RATs (e.g., eNB using LTE and gNB using NR). In the latter, the signaling connection between the two network nodes may be indirect via the CN.

Examples of AI/ML algorithms that could be trained and executed by a network node to determine a configuration of mobility settings parameters include supervised learning algorithms, deep learning algorithms, reinforcement learning algorithms, contextual multi-armed bandit algorithms, autoregression algorithms, etc., or combinations thereof. Such algorithms may exploit functional approximation models, such as neural networks (e.g., feedforward neural networks, deep neural networks, recurrent neural networks, convolutional neural networks, etc.), which can be trained to approximate a value function providing an indication of how good a particular configuration of mobility settings parameters is. Examples of reinforcement learning algorithms include deep reinforcement learning (e.g., deep Q-network (DQN), proximal policy optimization (PPO), double Q-learning), actor-critic algorithms (e.g., A2C, A3C, actor-critic with experience replay, etc.), policy gradient algorithms, off-policy learning algorithms, etc.

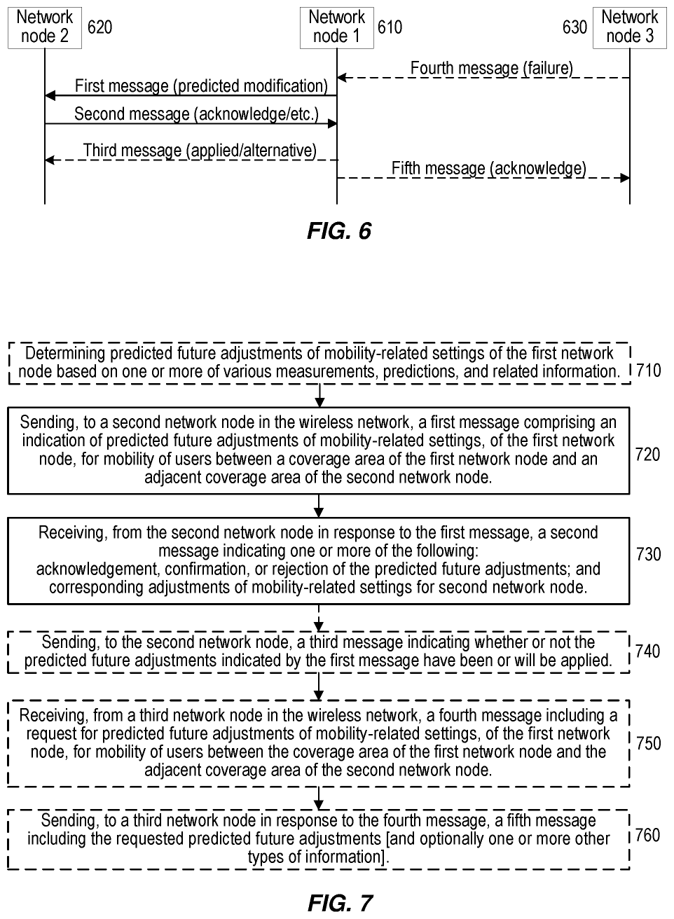

FIG. 6 shows a signal flow between a first network node (610), a second network node (620), and a third network node (630) that illustrates various embodiments of the present disclosure. The following discussion will refer to the messages of the signal flow shown in FIG. 6. Optional messages are indicated by dashed lines.

In some embodiments, the first network node can determine predicted future adjustments of mobility-related settings of the first network node, e.g., for mobility of users between a coverage area of the first network node and an adjacent coverage area of a second network node. The predicted future adjustments can be based on predicted traffic and/or load. The first network node sends to the second network node a first message (e.g., FIRST MOBILITY ADJUSTMENT), that can include an indication of the predicted future adjustments as well as any of the following:
an identifier associated with the predicted future adjustments;
conditions under which the predicted future adjustments will be applied by the first network node, such as one or more of the following:
   load and/or load variation (e.g., increase, decrease) in a coverage area associated with a previous or current mobility trigger point and an adjusted mobility trigger point (e.g., in the predicted future adjustments) relative to (e.g., above, below, between) one or more load thresholds. “Load” can be measured and/or specified in terms of metrics signaled in a Resource Status Update message.
   at a particular time, e.g., expiration of a defined timer, after a certain duration, at the start of a particular radio frame, etc.
indication (e.g., request or command) that the second network node should perform corresponding adjustments of mobility-related settings of the second network node, e.g., for mobility of users between the coverage area of the second network node and the adjacent coverage area of the first network node, with the requested corresponding adjustments optionally included in the first message;
conditions under which the corresponding should be performed by the second network node, which can be implicit from the conditions under which the predicted future adjustments will be applied by the first network node, or can indicated explicitly such as one or more of the following:
   an increase/decrease in load in a coverage area defined between a previous or current mobility trigger point and an adjusted mobility trigger point, up to or above or below a given load threshold;
   at a particular time, e.g., expiration of a defined timer, after a certain duration, at the start of a particular radio frame, etc.
indication of an actual or estimated amount of traffic and/or load that may be transferred from first network node to second network node after the predicted future adjustments are applied by the first network node (and by the second network node, if such corresponding adjustments are indicated in the first message);
indication of an actual or estimated amount of traffic and/or load that will be transferred from first network node to second network node proactively before the predicted future adjustments are applied by the first network node;
a timing indication (e.g., a timer or a time stamp), from which the second network node can deduce that the first network node will apply the predicted future adjustments upon occurrence (e.g., timer expiration).
a timing indication (e.g., a timer or a time stamp), from which the second network node can deduce that the first network node will not apply the predicted future adjustments upon occurrence (e.g., timer expiration).
indication of a validity time for the predicted future adjustments (e.g., starting time, ending time, time interval, etc.).
indication of accuracy, precision, validity, reliability, stability, likelihood, etc. of the predicted future adjustments and/or of predicted traffic and/or load information used to determine the predicted future adjustments.

In various embodiments, the predicted future adjustments indicated by the first network node in the first message can include adjustments to triggers, hysteresis, time to trigger, measurement offsets, etc. associated with mobility operations. Furthermore, in various embodiments, each predicted future adjustment can be specific to one or more of the following:
one or more cells, e.g., related to movements of users between at least one cell of the first network node and at least one cell of the second network node;
one or more SSB beams, e.g., related to movements of users between at least one SSB beam of the first network node and at least one SSB beam of the second network node. For example, per-SSB parameters may be indicated as an absolute value or an offset (e.g., per-SSB offset) with respect to the corresponding cell-level parameter (if present).
one or more network slices, e.g., related to movements of users with one or more slices (associated with S-NSSAIs) between the first network node and the second network node. For example, per-slice parameters may be indicated as an absolute value or an offset (e.g., per-slice offset) with respect to the corresponding cell-level parameter (if present).
one or more carrier frequencies, e.g., related to movements of users between at least one carrier frequency served by the first network node and at least one carrier frequency served by the second network node. For example, per-carrier frequency parameters may be indicated as an absolute value or an offset (e.g., per-carrier frequency offset) with respect to the corresponding cell-level parameter (if present).
one or more services.
one or more public land mobile networks (PLMNs).
one or more UEs.

As a specific example, the first message can indicate a change of a cell level offset with respect to specific target mobility measurements on parameters such as RSRP, RSRQ, SINR. When the measurement reaches such offset with respect to the established target, a handover is triggered. Such offset may be configured per target cell, per source cell, per source/target cell pair, per UE, per service, per slice (e.g., for each S-NSSAI), or per some combination of these parameters.

In various embodiments, each predicted future adjustment can be indicated as absolute value (e.g., dBm), scaled absolute value, relative to a reference value (e.g., previously signaled or preconfigured), count, index to a table of values, etc.

In some embodiments, the corresponding adjustments of mobility-related settings of the second network node can be indicated in the first message in the same or a similar manner as the predicted future adjustments of the first network node. However, it is possible that the predicted future adjustments are to different parameters (e.g., subset, superset, overlapping or non-overlapping sets) than the corresponding adjustments.

In various embodiments, the first message can be implemented as a new message (e.g., called MOBILITY CHANGE COORDINATION REQUEST or a similar name) or as an existing message (e.g., XnAP MOBILITY CHANGE REQUEST) extended with new IEs and/or fields.

In some embodiments, the first network node can receive from the second network node a second message (e.g., SECOND MOBILITY ADJUSTMENT) that can indicate one or more of the following:
acknowledgement of the first message;
confirmation or rejection of the predicted future adjustments of mobility-related settings of the first network node indicated in the first message, optionally with a cause value;
confirmation or rejection of the corresponding adjustments of mobility-related settings of the second network node indicated in the first message, optionally with a cause value;
corresponding adjustments (e.g., proposed or actual) of mobility-related settings of the second network node, which can be included whether or not the first message indicates corresponding adjustments for the second network node;
identifier associated with the corresponding adjustments for the second network node;
one or more limitations at the second network node with respect to the predicted future adjustments of the first network node and/or the corresponding adjustments of the second network node indicated in the first message (e.g., minimum and/or maximum limit for adjustments of mobility settings);
actual or estimated amount of traffic and/or load that may be transferred from second network node to first network node after the predicted future adjustments are applied by the first network node (and by the second network node, if such corresponding adjustments are indicated in the first message or the second message).

For example, the second network node may indicate a rejection (e.g., by Cause) in the third message when it is unable to commit to adjustments to mobility-related parameters indicated by and/or derived from the information received in the first message. Upon receiving a second message indicating a rejection, the first network node can prepare alternative adjustments to mobility-related parameters to send to the second network node (e.g., in another first message).

In various embodiments, the second message can be implemented as a new message or as an existing message (e.g., on XnAP or X2AP) extended with new IEs and/or fields.

For example, if the second message is used to acknowledge the first message, it can be realized as an extension of an existing message (e.g., XnAP MOBILITY CHANGE ACKNOWLEDGE) or as a newly defined message (e.g., MOBILITY CHANGE COORDINATION ACKNOWLEDGE, MOBILITY CHANGE COORDINATION RESPONSE, or a similar name).

As another example, if the second message is used to reject the first message, it can be realized as an extension of an existing message (e.g., XnAP MOBILITY CHANGE FAILURE) or as a newly defined message (e.g., MOBILITY CHANGE COORDINATION FAILURE or a similar name). As discussed above, the second message in this example can contain mobility related setting for the second network node (e.g., per-cell, per-SSB, per-slice, per-carrier frequency, per-service, per-PLMN, etc.).

As another example, if the second message is used to confirm the corresponding adjustments of mobility related setting of the second network node indicated in the first message, it can be realized as an extension of an existing message (e.g., XnAP MOBILITY CHANGE ACKNOWLEDGE) or as a newly defined message (e.g., MOBILITY CHANGE COORDINATION ACKNOWLEDGE, MOBILITY CHANGE COORDINATION RESPONSE, or a similar name).

In some embodiments, the first network node can send to the second network node a third message (e.g., THIRD MOBILITY ADJUSTMENT) that indicates to the second network node whether or not a previously communicated (e.g., in a first message) predicted future adjustments of mobility-related settings of the first network node is or will be applied. The third message may additionally indicate a starting time for the application of the previously communicated predicted future adjustments.

In some embodiments (e.g., as shown in FIG. 6), the first network node does not expect a response to the third message from the second network node. In other embodiments, the first network node expects a response to the third message from the second network node. The response can indicate to the first network node whether or not a previously communicated (e.g., in a second message) corresponding adjustments for the second network node is or will be applied.

In some embodiments, when the third message indicates to the second network node that the first network node will not apply previously communicated predicted future adjustments, the third message can also include an alternative (or new) predicted future adjustments that the first network node is going to apply. Alternately, the fourth message can include alternative (or new) actual adjustments of mobility-related settings that the first network node is going to apply. In this manner, the second network node can use this information to learn the accuracy of the prediction model used by the first network node by comparing the communicated predicted future adjustments and the actual adjustments to be applied by the first network node, which can impact future responses from the second network node.

There can be various reasons why the third message indicates that the predicted future adjustments of mobility-related settings of the first network node will not be applied. One possible reason is that conditions that were as basis for the predicted future adjustments did not occur and/or materialize. Another possible reason is that information received form the second network node in the second message (e.g., amount of traffic and/or load that may be transferred from second network node to first network node) created conditions that made the predicted future adjustments impossible, unfeasible, impractical, and/or unnecessary.

In various embodiments, the third message can be implemented as a new message (e.g., MOBILITY CHANGE COORDINATION NOTIFICATION or a similar name) or as an existing message (e.g., on XnAP or X2AP) extended with new IEs and/or fields.

In embodiments that do not employ a third message, the second network node can take various actions upon expiration of a timer configured by a value included in the first message. For example, the second network node can deduce that the first network node has applied the predicted adjustments upon expiration of the timer. Alternately, the second network node can deduce that the first network node has not applied the predicted adjustments upon expiration of the timer. In general, expiration of the timer should be interpreted by the second network node in a manner consistent with the meaning of the value by which the timer is configured.

In some embodiments, the first network node can receive from a third network node a fourth message (e.g., FOURTH MOBILITY ADJUSTMENT) including a request to receive from the first network node predicted future adjustments of mobility-related settings of the first network node, e.g., for mobility of users between a coverage area of the first network node and an adjacent coverage area of a second network node. In other words, the third network node can request the first network node to provide it with the same predicted future adjustments sent to the first network node in the first message. Although FIG. 6 shows the fourth message occurring before the first, second, and third messages, this order is used only for convenience and other orders of these messages are possible.

In various embodiments, the fourth message can be implemented as a new message (e.g., MOBILITY CHANGE COORDINATION REQUEST or a similar name) or as an existing message (e.g., on XnAP or X2AP) extended with new IEs and/or fields.

In some embodiments, the first network node sends to the third network node a fifth message (e.g., FIFTH MOBILITY ADJUSTMENT), which can be responsive to the fourth message or independent of a fourth message (e.g., unsolicited). The fifth message can include one or more of the following:
predicted future adjustments of mobility-related settings of the first network node;
corresponding adjustments of mobility related settings of the second network node;
an indication of whether the second network node has acknowledged, rejected, or confirmed the predicted future adjustments and/or the corresponding adjustments; and
an indication that the predicted future adjustments have been or will be applied by the first network node, optionally including a time of application.
   For example, the first network node can send two fifth messages to the third network node: a first indicating the predicted future adjustments and a second indicating that the predicted future adjustments indicated in the earlier fifth message have been or will be applied.

In various embodiments, the fifth message can be implemented as a new message (e.g., MOBILITY CHANGE COORDINATION ACKNOWLEDGE, MOBILITY CHANGE COORDINATION RESPONSE or a similar name) or as an existing message (e.g., on XnAP or X2AP) extended with new IEs and/or fields.

Certain embodiments can be realized as messages in protocols standardized by 3GPP for communication between network nodes. A first example implementation for XnAP defined in 3GPP TS 38.423 is given below. In this example, NG-RAN node 1 and NG-RAN node 2 are examples of the first network node and the second network node, respectively, discussed above.

**Begin exemplary text for 3GPP TS 38.423**

### 9.1.3.X1 Mobility Change Coordination Request

This message is sent by NG-RAN node₁ to NG-RAN node₂ to coordinate future adaptations of proposed mobility parameters.

Direction: NG-RAN node 1 to NG-RAN node 2.

| | | | | |
|---|---|---|---|---|
| IE/Group Name | Presence | Range | IE type/ref. | Semantics description |

| | | | |
|---|---|---|---|
| Message Type | M | 9.2.3.1 | |
| NG-RAN node1 Cell | M | Global NG-RAN Cell | |
| ID | | Identity 9.2.2.27 | |
| NG-RAN node2 Cell | M | Global NG-RAN Cell | |
| ID | | Identity 9.2.2.27 | |
| NG-RAN node1 | O | Mobility Parameters | Configuration change in NG- |
| Predicted Mobility | | Information 9.2.2.60 | RAN node1 cell |
| Parameters | | | |
| NG-RAN node2 | M | Mobility Parameters | Predicted configuration |
| Predicted Mobility | | Information 9.2.2.60 | change in NG-RAN node2 cell |
| Parameters | | | |
| Estimated Probability | M | INTEGER (1 . . . 100) | |
| Prediction validity | O | INTEGER (1 . . . 4095) | Estimated validity period in |
| | | | seconds. |
| Cause | M | 9.2.3.2 | |

### 9.1.3.X2 Mobility Change Coordination Acknowledge

This message is sent by NG-RAN node₂ to indicate to NG-RAN node, that Predicted Mobility Parameters proposed by NG-RAN node, were accepted.

Direction: NG-RAN node 2 to NG-RAN node 1.

| | | | | |
|---|---|---|---|---|
| | | | | Semantics |
| IE/Group Name | Presence | Range | IE type/ref. | description |

| | | |
|---|---|---|
| Message Type | M | 9.2.3.1 |
| NG-RAN node1 | M | Global NG- |
| Cell ID | | RAN Cell |
| | | Identity |
| | | 9.2.2.27 |
| NG-RAN node2 | M | Global NG- |
| Cell ID | | RAN Cell |
| | | Identity |
| | | 9.2.2.27 |
| Criticality | O | 9.2.3.2 |
| Diagnostics | | |

### 9.1.3.X3 Mobility Change Coordination Failure

This message is sent by the NG-RAN node₂ to indicate to NG-RAN node, that Predicted Mobility Parameters proposed by NG-RAN node, were refused.

Direction: NG-RAN node 2 to NG-RAN node 1.

| | | | | |
|---|---|---|---|---|
| | | | | Semantics |
| IE/Group Name | Presence | Range | IE type/ref. | description |

| | | |
|---|---|---|
| Message Type | M | 9.2.3.1 |
| NG-RAN node1 | M | Global NG- |
| Cell ID | | RAN Cell |
| | | Identity |
| | | 9.2.2.27 |
| NG-RAN node2 | M | Global NG- |
| Cell ID | | RAN Cell |
| | | Identity |
| | | 9.2.2.27 |
| Cause | M | 9.2.3.2 |
| Predicted | O | 9.2.2.61 |
| Mobility | | |
| Parameters | | |
| Modification Range | | |
| Criticality | O | 9.2.3.2 |
| Diagnostics | | |

### 9.1.3.X4 Mobility Change Coordination Notification

This message is sent by the NG-RAN node, to notify to NG-RAN node₂ that Predicted Mobility Parameters proposed by NG-RAN node₁ are taken in use.

Direction: NG-RAN node 2 to NG-RAN node 1.

| | | | | |
|---|---|---|---|---|
| | | | | Semantics |
| IE/Group Name | Presence | Range | IE type/ref. | description |

| | | |
|---|---|---|
| Message Type | M | 9.2.3.1 |
| NG-RAN node1 | M | Global NG- |
| Cell ID | | RAN Cell |
| | | Identity |
| | | 9.2.2.27 |
| NG-RAN node2 | M | Global NG- |
| Cell ID | | RAN Cell |
| | | Identity |
| | | 9.2.2.27 |
| Criticality | O | 9.2.3.2 |
| Diagnostics | | |

**End exemplary text for 3GPP TS 38.423***

Various features of the embodiments described above correspond to various operations illustrated in FIGS. 7-9, which show exemplary methods (e.g., procedures) for a first network node, a second network, and a third network node, respectively. In other words, various features of the operations described below correspond to various embodiments described above. Furthermore, the exemplary methods shown in FIGS. 7-9 can be used cooperatively to provide various benefits, advantages, and/or solutions to problems described herein. Although FIGS. 7-9 show specific blocks in particular orders, the operations of the exemplary methods can be performed in different orders than shown and can be combined and/or divided into blocks having different functionality than shown. Optional blocks or operations are indicated by dashed lines.

In particular, FIG. 7 shows an exemplary method (e.g., procedure) for a first network node of a wireless network, according to various embodiments of the present disclosure. The exemplary method can be performed by a network node (e.g., base station, eNB, gNB, ng-eNB, etc.) such as described elsewhere herein.

The exemplary method can include the operations of block 720, where the first network node can send, to a second network node in the wireless network, a first message comprising an indication of predicted future adjustments of mobility-related settings, of the first network node, for mobility of users between a coverage area of the first network node and an adjacent coverage area of the second network node. The exemplary method can also include the operations of block 730, where the first network node can receive, from the second network node in response to the first message, a second message indicating one or more of the following:
acknowledgement, confirmation, or rejection of the predicted future adjustments; and
corresponding adjustments (e.g., proposed or actual) of mobility-related settings for the second network node.

In some embodiments, the indication of the predicted future adjustments (e.g., in block 720) can include an indication of one or more of the following:
that the predicted future adjustments will be applied by the first network node based on one or more first conditions;
that the predicted future adjustments will not be applied by the first network node based on one or more second conditions; and
that corresponding adjustments of mobility-related settings should be made by the second network node for mobility of users between the coverage area of the second network node and the adjacent coverage area of the first network node.

In some of these embodiments, when the first message indicates that corresponding adjustments of mobility-related settings should be made by the second network node, the second message also indicates one or more of the following:
confirmation or rejection of the corresponding adjustments indicated in the first message; and
the corresponding adjustments, which are different than the corresponding adjustments indicated in the first message.

In some of these embodiments, one or more of the following applies:
when the second message includes a rejection of the predicted future adjustments indicated in the first message, the second message also includes a cause value indicating a reason why the predicted future adjustments are rejected by the second network node; and
when the second message includes a rejection of the corresponding adjustments indicated in the first message, the second message also includes a cause value indicating a reason why the corresponding adjustments are rejected by the second network node.

In some of these embodiments, the mobility-related settings for the first network node include a first mobility trigger point, and a coverage area of the first network node corresponds to a difference between a previous or current value of the first mobility trigger point and an adjusted value of the first mobility trigger point. In such embodiments, the one or more first conditions can include any of the following:
load and/or load variation in the coverage area of the first network node being above, below, or between one or more first thresholds; and
a first time when or after which the predicted future adjustments will be applied, with the first time being indicated in the first message.
   In such embodiments, the one or more second conditions include any of the following:
load and/or load variation in the coverage area of the first network node being above, below, or between one or more second thresholds; and
a second time when or after which the predicted future adjustments have not been or will not be applied, the second time being indicated in the first message.

In some embodiments, the mobility-related settings for the second network node include a second mobility trigger point and a coverage area of the second network node corresponds to a difference between a previous or current value of the second mobility trigger point and an adjusted value of the second mobility trigger point. In such embodiments, the corresponding adjustments of mobility-related settings (i.e., indicated in the second message) are based on one or more of the following third conditions:
load and/or load variation in the coverage area of the second network node being above, below, or between one or more third thresholds; and
the first time.

In some embodiments, the predicted future adjustments indicated in the first message and the corresponding adjustments indicated in the second message can include at least one of the following:
adjustments to one or more of the following mobility-related settings: trigger points, hysteresis, time to trigger, and measurement offsets; and
adjustments specific to one or more of the following: one or more cells, one or more SSB beams, one or more CSI-RS beams, one or more network slices, one or more carrier frequencies, one or more services, one or more public land mobile networks (PLMNs), and one or more user equipment (UEs).

In some embodiments, the first message can also include one or more of the following:
an identifier associated with the predicted future adjustments;
an indication of accuracy, precision, validity, reliability, stability, and/or likelihood associated with the predicted future adjustments or with information used by the first network node to determine the predicted future adjustments;
an indication of load and/or traffic that is expected to be transferred from the first network node to the second network node after the predicted future adjustments are applied;
an indication of load and/or traffic that is expected to be transferred from the first network node to the second network node before the predicted future adjustments are applied; and
an indication of a validity time for the predicted future adjustments.

In some embodiments, the second message can also include one or more of the following:
an identifier associated with the corresponding adjustments;
one or more limitations at the second network node with respect to the predicted future adjustments of the first network node and/or the corresponding adjustments of the second network node indicated in the first message (e.g., minimum and/or maximum limit for adjustments of mobility settings);
actual or estimated amount of traffic and/or load to be transferred from second network node to first network node after one or more of the following:
   the predicted future adjustments indicated in the first message are applied by the first network node;
   the corresponding adjustments indicated in the first message are applied by the second network node; and
   the corresponding adjustments indicated in the second message are applied by the second network node.

In some embodiments, the second message also includes one or more of the following:
an identifier associated with the corresponding adjustments;
one or more limitations at the second network node with respect to the predicted future adjustments of the first network node and/or the corresponding adjustments of the second network node indicated in the first message;
actual or estimated amount of traffic and/or load to be transferred from second network node to first network node after one or more of the following:
   the predicted future adjustments indicated in the first message are applied by the first network node;
   the corresponding adjustments indicated in the first message are applied by the second network node; and
   the corresponding adjustments indicated in the second message are applied by the second network node.

In some embodiments, the exemplary method can also include the operations of block 740, where the first network node can send, to the second network node, a third message indicating whether or not the predicted future adjustments indicated by the first message have been or will be applied. In some of these embodiments, when the third message indicates that the predicted future adjustments indicated by the first message have been or will be applied, the third message also includes a starting time for application of the predicted future adjustments by the first network node. In other of these embodiments, when the third message indicates that the predicted future adjustments indicated by the first message have not been or will not be applied, the third message also includes an indication of one or more of the following:
revised predicted future adjustments of mobility-related settings of the first network node;
actual adjustments of the mobility-related settings of the first network node that have been or will be applied by the first network node; and
revised corresponding adjustments of mobility-related settings that should be made by the second network node.

In some embodiments, the exemplary method can also include the operations of block 750, where the first network node can receive, from a third network node in the wireless network, a fourth message including a request for predicted future adjustments of mobility-related settings, of the first network node, for mobility of users between the coverage area of the first network node and the adjacent coverage area of the second network node. In some of these embodiments, the exemplary method can also include the operations of block 760, where the first network node can send, to the third network node in response to the fourth message, a fifth message including one or more of the following:
the predicted future adjustments of mobility-related settings of the first network node;
the corresponding adjustments of mobility related settings of the second network node;
an indication of whether the second network node has acknowledged, rejected, or confirmed the predicted future adjustments and/or the corresponding adjustments;
an indication that the predicted future adjustments have been or will be applied by the first network node; and
a time of application for the predicted future adjustments.

In some of these embodiments, the exemplary method can also include the operations of block 710, where the first network node can determine the predicted future adjustments of mobility-related settings of the first network node (e.g., indicated in block 720) based on one or more of the following:
measured load and/or traffic (including measured variations) during one or more current and/or previous time periods for one or more of the following: one or more cells served by the first network node, one or more cells served by the second network node, one or more beams served by the first network node, and one or more beams served by the second network node,
predicted load and/or traffic (including predicted variations) during one or more subsequent time periods for one or more of the following: the one or more cells served by the first network node, the one or more cells served by the second network node, the one or more beams served by the first network node, and the one or more beams served by the second network node;
accuracy, precision, validity, reliability, stability, and/or likelihood associated with the predicted load and/or traffic;
measurements made by one or more UEs on the one or more cells served by the first network node, the one or more cells served by the second network node, the one or more beams served by the first network node, and/or the one or more beams served by the second network node; and
current and/or predicted future radio-related conditions in the wireless network, such as examples such as changes in interference, addition/removal of neighbor cells, changes in cell boundaries, changes in frequencies used, changes in radio propagation obstructions such as walls, buildings, etc.

In some of these embodiments, the measured load and/or traffic and the predicted load and/or traffic are based on one or more of the following metrics: data volume, number of UEs, packet size, bit rate, packet delay, packet delay jitter, packet error rate, number of consecutive failed packets, inter-packet arrival time, service downtime. In some variants, each metric can be represented as one of the following:
one or more statistics including average, maximum, minimum, standard deviation, and variance;
a total or aggregate amount; and
measured or predicted change with respect to current traffic, a previous time interval, or a previously reported measurement or prediction.

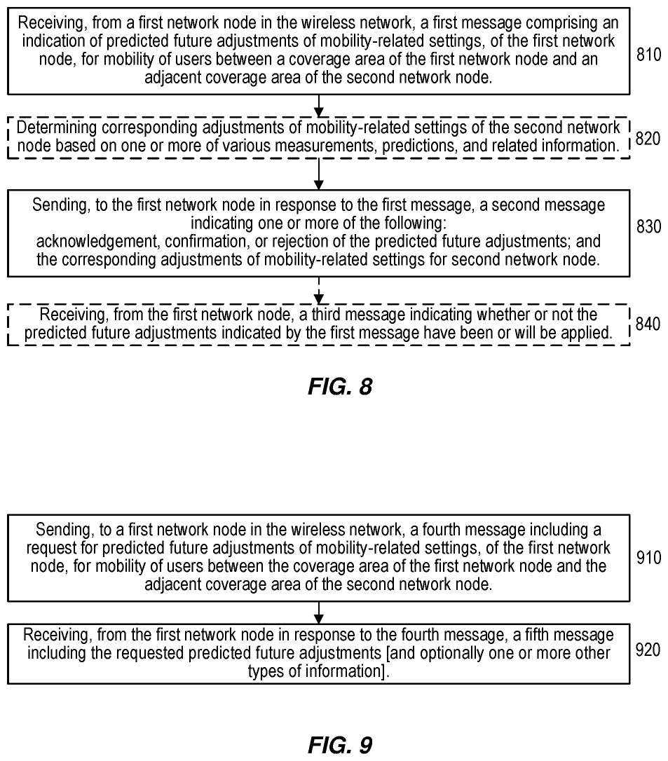

In addition, FIG. 8 shows an exemplary method (e.g., procedure) for a second network node of a wireless network, according to various embodiments of the present disclosure. The exemplary method can be performed by a network node (e.g., base station, eNB, gNB, ng-eNB, etc.) such as described elsewhere herein.

The exemplary method can include the operations of block 810, where the second network node can receive, from a first network node of the wireless network, a first message comprising an indication of predicted future adjustments of mobility-related settings, of the first network node, for mobility of users between a coverage area of the first network node and an adjacent coverage area of the second network node. The exemplary method can also include the operations of block 830, where the second network node can send, to the first network node in response to the first message, a second message indicating one or more of the following:
acknowledgement, confirmation, or rejection of the predicted future adjustments; and
corresponding adjustments of mobility-related settings for the second network node.

In some embodiments, the indication of the predicted future adjustments (e.g., in block 810) comprises one or more of the following indications:
that the predicted future adjustments will be applied by the first network node based on one or more first conditions;
that the predicted future adjustments will not be applied by the first network node based on one or more second conditions; and
that corresponding adjustments of mobility-related settings should be made by the second network node for mobility of users between the coverage area of the second network node and the adjacent coverage area of the first network node.

In some of these embodiments, when the first message indicates that corresponding adjustments of mobility-related settings should be made by the second network node, the second message also indicates one or more of the following:
confirmation or rejection of the corresponding adjustments indicated in the first message; and
the corresponding adjustments, which are different than the corresponding adjustments indicated in the first message.

In some of these embodiments, one or more of the following applies:
when the second message includes a rejection of the predicted future adjustments indicated in the first message, the second message also includes a cause value indicating a reason why the predicted future adjustments are rejected by the second network node; and
when the second message includes a rejection of the corresponding adjustments indicated in the first message, the second message also includes a cause value indicating a reason why the corresponding adjustments are rejected by the second network node.

In some of these embodiments, the mobility-related settings for the first network node include a first mobility trigger point and a coverage area of the first network node corresponds to a difference between a previous or current value of the first mobility trigger point and an adjusted value of the first mobility trigger point. In such embodiments, the one or more first conditions can include any of the following:
load and/or load variation in the coverage area of the first network node being above, below, or between one or more first thresholds; and
a first time when or after which the predicted future adjustments will be applied, with the first time being indicated in the first message.

In such embodiments, the one or more second conditions include any of the following:
load and/or load variation in the coverage area of the first network node being above, below, or between one or more second thresholds; and
a second time when or after which the predicted future adjustments have not been or will not be applied, the second time being indicated in the first message.

In some embodiments, the mobility-related settings for the second network node include a second mobility trigger point and a coverage area of the second network node corresponds to a difference between a previous or current value of the second mobility trigger point and an adjusted value of the second mobility trigger point. In such embodiments, the corresponding adjustments of mobility-related settings (i.e., indicated in the second message) are based on one or more of the following third conditions:
load and/or load variation in the coverage area of the second network node being above, below, or between one or more third thresholds; and
the first time.

In some embodiments, the predicted future adjustments indicated in the first message and the corresponding adjustments indicated in the second message can include at least one of the following:
adjustments to one or more of the following mobility-related settings: trigger points, hysteresis, time to trigger, and measurement offsets; and
adjustments specific to one or more of the following: one or more cells, one or more SSB beams, one or more CSI-RS beams, one or more network slices, one or more carrier frequencies, one or more services, one or more public land mobile networks (PLMNs), and one or more user equipment (UEs).

In some embodiments, the first message can also include one or more of the following:
an identifier associated with the predicted future adjustments;
an indication of accuracy, precision, validity, reliability, stability, and/or likelihood associated with the predicted future adjustments or with information used by the first network node to determine the predicted future adjustments;
an indication of load and/or traffic that is expected to be transferred from the first network node to the second network node after the predicted future adjustments are applied;
an indication of load and/or traffic that is expected to be transferred from the first network node to the second network node before the predicted future adjustments are applied; and
an indication of a validity time for the predicted future adjustments.

In some embodiments, the second message can also include one or more of the following:
an identifier associated with the corresponding adjustments;
one or more limitations at the second network node with respect to the predicted future adjustments of the first network node and/or the corresponding adjustments of the second network node indicated in the first message (e.g., minimum and/or maximum limit for adjustments of mobility settings);
actual or estimated amount of traffic and/or load to be transferred from second network node to first network node after one or more of the following:
   the predicted future adjustments indicated in the first message are applied by the first network node;
   the corresponding adjustments indicated in the first message are applied by the second network node; and
   the corresponding adjustments indicated in the second message are applied by the second network node.

In some embodiments, the second message also includes one or more of the following:
an identifier associated with the corresponding adjustments;
one or more limitations at the second network node with respect to the predicted future adjustments of the first network node and/or the corresponding adjustments of the second network node indicated in the first message;
actual or estimated amount of traffic and/or load to be transferred from second network node to first network node after one or more of the following:
   the predicted future adjustments indicated in the first message are applied by the first network node;
   the corresponding adjustments indicated in the first message are applied by the second network node; and
   the corresponding adjustments indicated in the second message are applied by the second network node.

In some embodiments, the exemplary method can also include the operations of block 840, where the second network node can receive, from the first network node, a third message indicating whether or not the predicted future adjustments indicated by the first message have been or will be applied. In some of these embodiments, when the third message indicates that the predicted future adjustments indicated by the first message have been or will be applied, the third message also includes a starting time for application of the predicted future adjustments by the first network node. In other of these embodiments, when the third message indicates that the predicted future adjustments indicated by the first message have not been or will not be applied, the third message also includes an indication of one or more of the following:
revised predicted future adjustments of mobility-related settings of the first network node;
actual adjustments of the mobility-related settings of the first network node that have been or will be applied by the first network node; and
revised corresponding adjustments of mobility-related settings that should be made by the second network node.

In some embodiments, the exemplary method can also include the operations of block 820, where the second network node can determine the corresponding adjustments of mobility-related settings of the second network node, indicated in the second message, based on one or more of the following:
the predicted future adjustments of mobility-related settings of the first network node, indicated in the first message;
measured load and/or traffic (including measured variations) during one or more current and/or previous time periods for one or more of the following: one or more cells served by the first network node, one or more cells served by the second network node, one or more beams served by the first network node, and one or more beams served by the second network node,
predicted load and/or traffic (including predicted variations) during one or more subsequent time periods for one or more of the following: the one or more cells served by the first network node, the one or more cells served by the second network node, the one or more beams served by the first network node, and the one or more beams served by the second network node;
accuracy, precision, validity, reliability, stability, and/or likelihood associated with the predicted load and/or traffic;
measurements made by one or more UEs on the one or more cells served by the first network node, the one or more cells served by the second network node, the one or more beams served by the first network node, and/or the one or more beams served by the second network node; and
current and/or predicted future radio-related conditions in the wireless network, such as examples such as changes in interference, addition/removal of neighbor cells, changes in cell boundaries, changes in frequencies used, changes in radio propagation obstructions such as walls, buildings, etc.

In some of these embodiments, the measured load and/or traffic and the predicted load and/or traffic are based on one or more of the following metrics: data volume, number of UEs, packet size, bit rate, packet delay, packet delay jitter, packet error rate, number of consecutive failed packets, inter-packet arrival time, service downtime. In some variants, each metric can be represented as one of the following:
one or more statistics including average, maximum, minimum, standard deviation, and variance;
a total or aggregate amount; and
measured or predicted change with respect to current traffic, a previous time interval, or a previously reported measurement or prediction.

In addition, FIG. 9 shows an exemplary method (e.g., procedure) for a third network node of a wireless network, according to various embodiments of the present disclosure. The exemplary method can be performed by a network node (e.g., base station, eNB, gNB, ng-eNB, etc.) such as described elsewhere herein.

The exemplary method can include the operations of block 910, where the third network node can send, to a first network node in the wireless network, a fourth message including a request for predicted future adjustments of mobility-related settings, of the first network node, for mobility of users between the coverage area of the first network node and the adjacent coverage area of a second network node of the wireless network. The exemplary method can also include the operations of block 920, where the third network node can receive, from the first network node in response to the fourth message, a fifth message including an indication of the requested predicted future adjustments.

In some embodiments, the fifth message can also include one or more of the following:
corresponding adjustments of mobility related settings of the second network node;
an indication of whether the second network node has acknowledged, rejected, or confirmed the predicted future adjustments and/or the corresponding adjustments;
an indication that the predicted future adjustments have been or will be applied by the first network node;
and
a time of application for the predicted future adjustments.

In some embodiments, the predicted future adjustments indicated in the fifth message and the corresponding adjustments indicated in the fifth message can include at least one of the following:
adjustments to one or more of the following mobility-related settings: trigger points, hysteresis, time to trigger, and measurement offsets; and
adjustments specific to one or more of the following: one or more cells, one or more SSB beams, one or more CSI-RS beams, one or more network slices, one or more carrier frequencies, one or more services, one or more public land mobile networks (PLMNs), and one or more user equipment (UEs).

In some embodiments, the fifth message can also include one or more of the following:
an identifier associated with the predicted future adjustments;
an indication of accuracy, precision, validity, reliability, stability, and/or likelihood associated with the predicted future adjustments or with information used by the first network node to determine the predicted future adjustments;
an indication of load and/or traffic that is expected to be transferred from the first network node to the second network node after the predicted future adjustments are applied;
an indication of load and/or traffic that is expected to be transferred from the first network node to the second network node before the predicted future adjustments are applied; and
an indication of a validity time for the predicted future adjustments.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

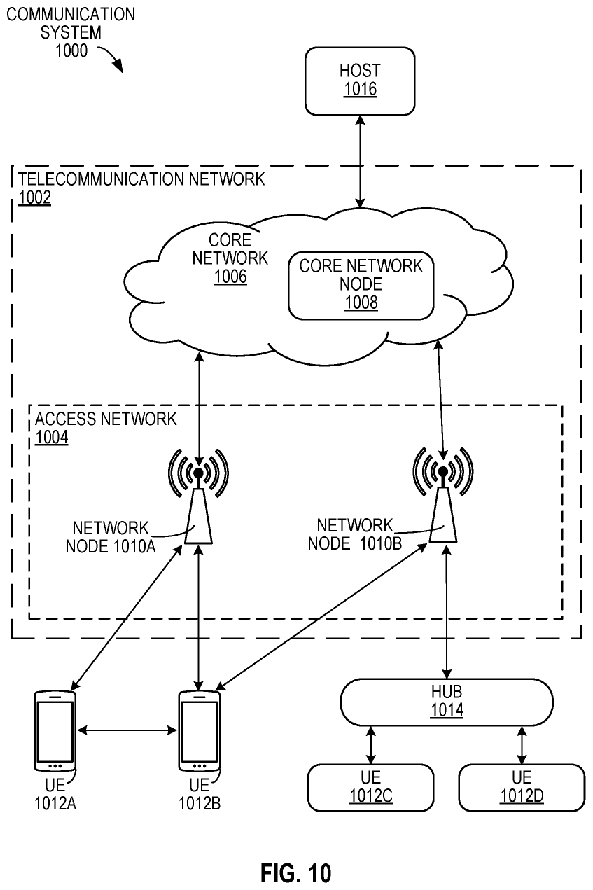

FIG. 10 shows an example of a communication system 1000 in accordance with some embodiments. In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be director indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002 and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

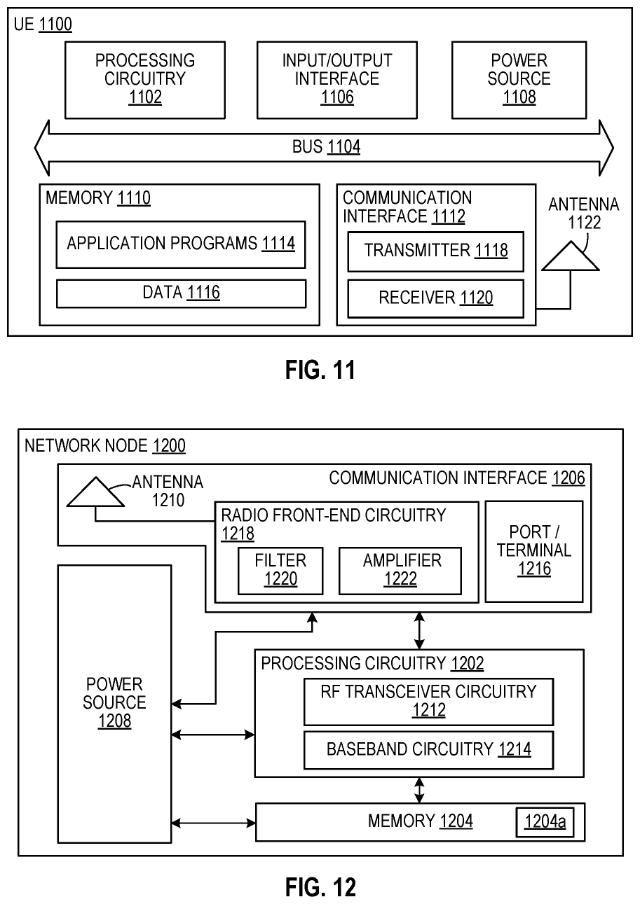

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions (referred to collectively as computer program product 1204a) capable of being executed by the processing circuitry 1202 and utilized by the network node 1200. The memory 1204 may be used to store any calculations made by the processing circuitry 1202 and/or any data received via the communication interface 1206. In some embodiments, processing circuitry 1202 and memory 1204 can be integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

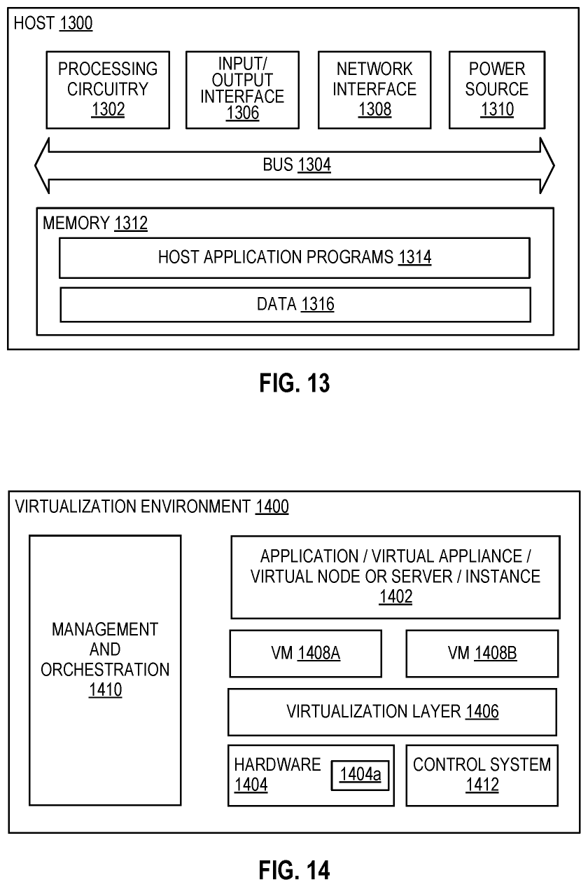

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300, or data generated by the host 1300 for a UE. Embodiments of the host 1300 may utilize all or various subsets of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions (referred to collectively as computer program product 1404a) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

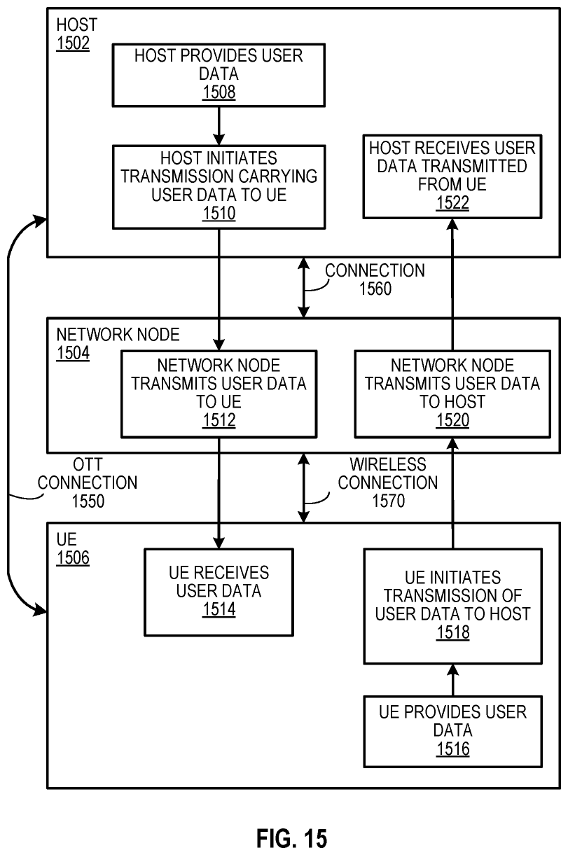

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, embodiments described herein can enable network nodes to cope with predicted changes to traffic or load, such as peaks of load or interference localized at the edges of its cells (or portions thereof, such as beams) that border other cells (or portions thereof) served by a different network node. For example, handover trigger points can be temporarily adjusted to address such predicted traffic or load, which can reduce and/or eliminate degradations in performance such as lower user data throughput and a higher incidence or rate of UE connections to the network being dropped and/or lost. Furthermore, receiving information about predicted mobility-related adjustments by a first network node can facilitate a second network node to proactively handover one or more UEs to the first network node, which can counteract potential and/or expected handover of traffic from the first network node to the second network node based on the predicted mobility-related adjustments by the first network node.

These and other specific technical improvements provided by embodiments described herein can result in an overall improvement in QoS/quality of experience (QoE) for users as well as better utilization of the network resources by the network operator. These improvements can increase the value of OTT services to end users and service providers through increased UE battery life as well as better reliability, less latency, and/or better QoS/quality of experience (QoE) for OTT services.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:
A1. A method for a first network node of a wireless network, the method comprising:
   sending, to a second network node in the wireless network, a first message comprising an indication of predicted future adjustments of mobility-related settings, of the first network node, for mobility of users between a coverage area of the first network node and an adjacent coverage area of a second network node of the wireless network; and
   receiving, from the second network node in response to the first message, a second message indicating one or more of the following:
      acknowledgement, confirmation, or rejection of the predicted future adjustments; and
      proposed corresponding adjustments of mobility-related settings for the second network node.
A2. The method of embodiment A1, wherein the indication of the predicted future adjustments comprises one or more of the following indications:
   that the predicted future adjustments will be implemented by the first network node based on one or more first conditions;
   that the predicted future adjustments will not be implemented by the first network node based on one or more second conditions; and
   that corresponding adjustments of mobility-related settings should be made by the second network node for mobility of users between the coverage area of the second network node and the adjacent coverage area of the first network node.
A3. The method of embodiment A2, wherein the one or more first conditions include any of the following:
   load and/or load variation in a coverage area, of the first network node, associated with a previous or current mobility trigger point and an adjusted mobility trigger point is above, below, or between one or more first thresholds; and
   a first time, which is indicated in the first message.
A4. The method of embodiment A3, wherein the corresponding adjustments of mobility-related settings are based on one or more of the following third conditions:
   load and/or load variation in a coverage area, of the second network node, associated with a previous or current mobility trigger point and an adjusted mobility trigger point is above, below, or between one or more third thresholds; and
   the first time.
A5. The method of any of embodiments A2-A4, wherein the one or more second conditions include any of the following:
   load and/or load variation in a coverage area, of the first network node, associated with the previous or current mobility trigger point and the adjusted mobility trigger point is above, below, or between one or more second thresholds; and
   a second time, which is indicated in the first message.
A6. The method of any of embodiments A2-A5, wherein the predicted future adjustments and the corresponding adjustments include adjustments to one or more of the following mobility-related settings: trigger points, hysteresis, time to trigger, and measurement offsets.
A7. The method of any of embodiments A2-A6, wherein the predicted future adjustments and the corresponding adjustments include adjustments specific to one or more of the following: one or more cells, one or more SSB beams, one or more CSI-RS beams, one or more network slices, one or more carrier frequencies, one or more services, one or more public land mobile networks (PLMNs), and one or more user equipment (UEs).
A8. The method of any of embodiments A2-A7, wherein when the first message indicates that corresponding adjustments of mobility-related settings should be made by the second network node, the second message also indicates one or more of the following:
   confirmation or rejection of the corresponding adjustments indicated in the first message; and
   the proposed corresponding adjustments, which are different than the corresponding adjustments indicated in the first message.
A9. The method of embodiment A8, wherein one or more of the following applies:
   when the second message includes a rejection of the predicted future adjustments, the second message also includes a cause value indicating a reason why the predicted future adjustments are rejected by the second network node; and
   when the second message includes a rejection of the corresponding adjustments, the second message also includes a cause value indicating a reason why the corresponding adjustments are rejected by the second network node.
A10. The method of any of embodiments A1-A9, wherein the first message also includes one or more of the following:
   an identifier associated with the predicted future adjustments;
   an indication of accuracy, precision, validity, reliability, stability, and/or likelihood associated with the predicted future adjustments or with information used by the first network node to determine the predicted future adjustments;
   an indication of load and/or traffic that is expected to be transferred from the first network node to the second network node after the predicted future adjustments are applied;
   an indication of load and/or traffic that is expected to be transferred from the first network node to the second network node before the predicted future adjustments are applied; and
   an indication of a validity time for the predicted future adjustments.
A11. The method of embodiment A1-A10, wherein the second message also includes one or more of the following:
   an identifier associated with the proposed corresponding adjustments;
   one or more limitations at the second network node with respect to the predicted future adjustments of the first network node and/or the corresponding adjustments of the second network node indicated in the first message (e.g., minimum and/or maximum limit for adjustments of mobility settings);
   actual or estimated amount of traffic and/or load to be transferred from second network node to first network node after one or more of the following:
      the predicted future adjustments indicated in the first message are applied by the first network node;
      the corresponding adjustments indicated in the first message are applied by the second network node; and
      the proposed corresponding adjustments indicated in the second message are applied by the second network node.
A12. The method of any of embodiments A1-A11, further comprising sending, to the second network node, a third message indicating whether or not the predicted future adjustments indicated by the first message have been or will be applied.
A13. The method of embodiment A12, wherein when the third message indicates that the predicted future adjustments indicated by the first message have been or will be applied, the third message also includes a starting time for application of the predicted future adjustments by the first network node.
A14. The method of embodiment A12, wherein when the third message indicates that the predicted future adjustments indicated by the first message have not been or will not be applied, the third message also includes an indication of one or more of the following:
   revised predicted future adjustments of mobility-related settings of the first network node;
   actual adjustments of the mobility-related settings of the first network node that have been or will be applied by the first network node; and
   revised corresponding adjustments of mobility-related settings that should be made by the second network node.
A15. The method of any of embodiments A1-A14, further comprising receiving, from a third network node in the wireless network, a fourth message including a request for predicted future adjustments of mobility-related settings, of the first network node, for mobility of users between the coverage area of the first network node and the adjacent coverage area of the second network node.
A16. The method of embodiment A15, further comprising sending, to the third network node in response to the fourth message, a fifth message including one or more of the following:
   the predicted future adjustments of mobility-related settings of the first network node;
   corresponding adjustments of mobility related settings of the second network node;
   an indication of whether the second network node has acknowledged, rejected, or confirmed the predicted
   future adjustments and/or the corresponding adjustments;
   an indication that the predicted future adjustments have been or will be applied by the first network node; and
   a time of application for the predicted future adjustments.
A17. The method of any of embodiments A1-A16, further comprising determining the predicted future adjustments of mobility-related settings of the first network node based on one or more of the following:
   measured load and/or traffic during one or more current and/or previous time periods for one or more of the following: one or more cells served by the first network node, one or more cells served by the second network node, one or more beams served by the first network node, and one or more beams served by the second network node;
   predicted load and/or traffic during one or more subsequent time periods for one or more of the following: the one or more cells served by the first network node, the one or more cells served by the second network node, the one or more beams served by the first network node, and the one or more beams served by the second network node;
   accuracy, precision, validity, reliability, stability, and/or likelihood associated with the predicted load and/or traffic;
   measurements made by one or more UEs on the one or more cells served by the first network node, the one or more cells served by the second network node, the one or more beams served by the first network node, and/or the one or more beams served by the second network node; and
   current and/or predicted future environmental conditions related to the wireless network.
A18. The method of embodiment A17, wherein the measured load and/or traffic and the predicted load and/or traffic are based on one or more of the following metrics: data volume, number of UEs, packet size, bit rate, packet delay, packet delay jitter, packet error rate, number of consecutive failed packets, inter-packet arrival time, service downtime.
A19. The method of embodiment A18, wherein each metric is represented as one of the following:
   one or more statistics including average, maximum, minimum, standard deviation, and variance; a total or aggregate amount; and
   measured or predicted change with respect to current traffic, a previous time interval, or a previously reported measurement or prediction.
B1. A method for a second network node of a wireless network, the method comprising:
   receiving, from a first network node in the wireless network, a first message comprising an indication of predicted future adjustments of mobility-related settings, of the first network node, for mobility of users between a coverage area of the first network node and an adjacent coverage area of the second network node; and
   sending, to the first network node in response to the first message, a second message indicating one or more of the following:
      acknowledgement, confirmation, or rejection of the predicted future adjustments; and
      proposed corresponding adjustments of mobility-related settings for the second network node.
B2. The method of embodiment B1, wherein the indication of the predicted future adjustments includes an indication of one or more of the following:
   that the predicted future adjustments will be implemented by the first network node based on one or more first conditions;
   that the predicted future adjustments will not be implemented by the first network node based on one or more second conditions; and
   that corresponding adjustments of mobility-related settings should be made by the second network node for mobility of users between the coverage area of the second network node and the adjacent coverage area of the first network node.
B3. The method of embodiment B2, wherein the one or more first conditions include any of the following:
   load and/or load variation in a coverage area, of the first network node, associated with a previous or current mobility trigger point and an adjusted mobility trigger point is above, below, or between one or more first thresholds; and
   a first time, which is indicated in the first message.
B4. The method of embodiment B3, wherein the corresponding adjustments of mobility-related settings are based on one or more of the following third conditions:
   load and/or load variation in a coverage area, of the second network node, associated with a previous or current mobility trigger point and an adjusted mobility trigger point is above, below, or between one or more third thresholds; and
   the first time.
B5. The method of any of embodiments B2-B4, wherein the one or more second conditions include any of the following:
   load and/or load variation in a coverage area, of the first network node, associated with the previous or current mobility trigger point and the adjusted mobility trigger point is above, below, or between one or more second thresholds; and
   a second time, which is indicated in the first message.
B6. The method of any of embodiments B2-B5, wherein the predicted future adjustments and the corresponding adjustments include adjustments to one or more of the following mobility-related settings: trigger points, hysteresis, time to trigger, and measurement offsets.
B7. The method of any of embodiments B2-B6, wherein the predicted future adjustments and the corresponding adjustments include adjustments specific to one or more of the following: one or more cells, one or more SSB beams, one or more CSI-RS beams, one or more network slices, one or more carrier frequencies, one or more services, one or more public land mobile networks (PLMNs), and one or more user equipment (UEs).
B8. The method of any of embodiments B2-B7, wherein when the first message indicates that corresponding adjustments of mobility-related settings should be made by the second network node, the second message also indicates one or more of the following:
   confirmation or rejection of the corresponding adjustments indicated in the first message; and
   the proposed corresponding adjustments, which are different than the corresponding adjustments indicated in the first message.
B9. The method of embodiment B8, wherein one or more of the following applies:
   when the second message includes a rejection of the predicted future adjustments, the second message also includes a cause value indicating a reason why the predicted future adjustments are rejected by the second network node; and
   when the second message includes a rejection of the corresponding adjustments, the second message also includes a cause value indicating a reason why the corresponding adjustments are rejected by the second network node.
B10. The method of any of embodiments B1-B9, wherein the first message also includes one or more of the following:
   an identifier associated with the predicted future adjustments;
   an indication of accuracy, precision, validity, reliability, stability, and/or likelihood associated with the predicted future adjustments or with information used by the first network node to determine the predicted future adjustments;
   an indication of load and/or traffic that is expected to be transferred from the first network node to the second network node after the predicted future adjustments are applied;
   an indication of load and/or traffic that is expected to be transferred from the first network node to the second network node before the predicted future adjustments are applied; and
   an indication of a validity time for the predicted future adjustments.
B11. The method of embodiment B1-B10, wherein the second message also includes one or more of the following:
   an identifier associated with the proposed corresponding adjustments;
   one or more limitations at the second network node with respect to the predicted future adjustments of the first network node and/or the corresponding adjustments of the second network node indicated in the first message (e.g., minimum and/or maximum limit for adjustments of mobility settings);
   actual or estimated amount of traffic and/or load to be transferred from second network node to first network node after one or more of the following:
      the predicted future adjustments indicated in the first message are applied by the first network node;
      the corresponding adjustments indicated in the first message are applied by the second network node; and
      the proposed corresponding adjustments indicated in the second message are applied by the second network node.
B12. The method of any of embodiments B1-B11, further comprising receiving, from the first network node, a third message indicating whether or not the predicted future adjustments indicated by the first message have been or will be applied.
B13. The method of embodiment B12, wherein when the third message indicates that the predicted future adjustments indicated by the first message have been or will be applied, the third message also includes a starting time for application of the predicted future adjustments by the first network node.
B14. The method of embodiment B12, wherein when the third message indicates that the predicted future adjustments indicated by the first message have not been or will not be applied, the third message also includes an indication of one or more of the following:
   revised predicted future adjustments of mobility-related settings of the first network node;
   actual adjustments of the mobility-related settings of the first network node that have been or will be applied by the first network node; and
   revised corresponding adjustments of mobility-related settings that should be made by the second network node.
B15. The method of any of embodiments B1-B16, further comprising determining the proposed corresponding adjustments of mobility-related settings of the second network node, indicated in the second message, based on one or more of the following:
   the predicted future adjustments of mobility-related settings of the first network node, indicated in the first message;
   measured load and/or traffic during one or more current and/or previous time periods for one or more of the following: one or more cells served by the first network node, one or more cells served by the second network node, one or more beams served by the first network node, and one or more beams served by the second network node;
   predicted load and/or traffic during one or more subsequent time periods for one or more of the following: the one or more cells served by the first network node, the one or more cells served by the second network node, the one or more beams served by the first network node, and the one or more beams served by the second network node;
   accuracy, precision, validity, reliability, stability, and/or likelihood associated with the predicted load and/or traffic;
   measurements made by one or more UEs on the one or more cells served by the first network node, the one or more cells served by the second network node, the one or more beams served by the first network node, and the one or more beams served by the second network node; and
   current and/or predicted future environmental conditions related to the wireless network.
B16. The method of embodiment B15, wherein the measured load and/or traffic and the predicted load and/or traffic are based on one or more of the following metrics: data volume, number of UEs, packet size, bit rate, packet delay, packet delay jitter, packet error rate, number of consecutive failed packets, inter-packet arrival time, service downtime.
B17. The method of embodiment B16, wherein each metric is represented as one of the following:
   one or more statistics including average, maximum, minimum, standard deviation, and variance; a total or aggregate amount; and
   measured or predicted change with respect to current traffic, a previous time interval, or a previously reported measurement or prediction.
C1. A method for a third network node of a wireless network, the method comprising:
   sending, to a first network node in the wireless network, a fourth message including a request for predicted future adjustments of mobility-related settings, of the first network node, for mobility of users between the coverage area of the first network node and the adjacent coverage area of a second network node of the wireless network; and
   receiving, from the first network node in response to the fourth message, a fifth message including an indication of the requested predicted future adjustments.
C2. The method of embodiment C1, wherein the fifth message also includes one or more of the following:
   corresponding adjustments of mobility related settings of the second network node;
   an indication of whether the second network node has acknowledged, rejected, or confirmed the predicted future adjustments and/or the corresponding adjustments;
   an indication that the predicted future adjustments have been or will be applied by the first network node; and
   a time of application for the predicted future adjustments.
C3. The method of embodiment C2, wherein the predicted future adjustments and the corresponding adjustments include adjustments to one or more of the following mobility-related settings: trigger points, hysteresis, time to trigger, and measurement offsets.
C4. The method of any of embodiments C2-C3, wherein the predicted future adjustments and the corresponding adjustments include adjustments specific to one or more of the following: one or more cells, one or more SSB beams, one or more CSI-RS beams, one or more network slices, one or more carrier frequencies, one or more services, one or more public land mobile networks (PLMNs), and one or more user equipment (UEs).
C5. The method of any of embodiments C1-C7, wherein the fifth message also includes one or more of the following:
   an identifier associated with the predicted future adjustments;
   an indication of accuracy, precision, validity, reliability, stability, and/or likelihood associated with the predicted future adjustments or with information used by the first network node to determine the predicted future adjustments;
   an indication of load and/or traffic that is expected to be transferred from the first network node to the second network node after the predicted future adjustments are applied;
   an indication of load and/or traffic that is expected to be transferred from the first network node to the second network node before the predicted future adjustments are applied; and
   an indication of a validity time for the predicted future adjustments.
D1. A first network node configured to operate in a wireless network, the first network node comprising:
   communication interface circuitry configured to communicate with user equipment (UEs) and with second and third network nodes in the wireless network; and
   processing circuitry operatively coupled to the communication interface circuitry, whereby the processing circuitry and the communication interface circuitry are configured to perform operations corresponding to any of the methods of embodiments A1-A19.
D2. A first network node configured to operate in a wireless network, the first network node being further configured to perform operations corresponding to any of the methods of embodiments A1-A19.
D3. A non-transitory, computer-readable medium storing computer-executable instructions that, when executed by processing circuitry of a first network node configured to operate in a wireless network, configure the first network node to perform operations corresponding to any of the methods of embodiments A1-A19.
D4. A computer program product comprising computer-executable instructions that, when executed by processing circuitry of a first network node configured to operate in a wireless network, configure the first network node to perform operations corresponding to any of the methods of embodiments A1-A19.
E1. A second network node configured to operate in a wireless network, the second network node comprising:
   communication interface circuitry configured to communicate with a first network node in the wireless network; and
   processing circuitry operatively coupled to the communication interface circuitry, whereby the processing circuitry and the communication interface circuitry are configured to perform operations corresponding to any of the methods of embodiments B1-B17.
E2. A second network node configured to operate in a wireless network, the second network node being further configured to perform operations corresponding to any of the methods of embodiments B1-B17.
E3. A non-transitory, computer-readable medium storing computer-executable instructions that, when executed by processing circuitry of a second network node configured to operate in a wireless network, configure the second network node to perform operations corresponding to any of the methods of embodiments B1-B17.
E4. A computer program product comprising computer-executable instructions that, when executed by processing circuitry of a third network node configured to operate in a wireless network, configure the third network node to perform operations corresponding to any of the methods of embodiments B1-B17.
F1. A third network node configured to operate in a wireless network, the third network node comprising:
   communication interface circuitry configured to communicate with a first network node in the wireless network; and
   processing circuitry operatively coupled to the communication interface circuitry, whereby the processing circuitry and the communication interface circuitry are configured to perform operations corresponding to any of the methods of embodiments C1-C5.
F2. A third network node configured to operate in a wireless network, the third network node being further configured to perform operations corresponding to any of the methods of embodiments C1-C5.
F3. A non-transitory, computer-readable medium storing computer-executable instructions that, when executed by processing circuitry of a third network node configured to operate in a wireless network, configure the third network node to perform operations corresponding to any of the methods of embodiments C1-C5.
F4. A computer program product comprising computer-executable instructions that, when executed by processing circuitry of a third network node configured to operate in a wireless network, configure the third network node to perform operations corresponding to any of the methods of embodiments C1-C5.

1.-46. (canceled)

47. A method for a first network node of a wireless network, the method comprising:
sending, to a second network node in the wireless network, a first message comprising an indication of predicted future adjustments of mobility-related settings, of the first network node, for mobility of users between a coverage area of the first network node and an adjacent coverage area of the second network node; and
receiving, from the second network node in response to the first message, a second message indicating one or more of the following:
acknowledgement, confirmation, or rejection of the predicted future adjustments; and
corresponding adjustments of mobility-related settings for the second network node.

48. The method of claim 47, further comprising determining the predicted future adjustments of mobility-related settings of the first network node based on one or more of the following:
measured load and/or traffic during one or more current and/or previous time periods for one or more of the following: one or more cells served by the first network node, one or more cells served by the second network node, one or more beams served by the first network node, and one or more beams served by the second network node;
predicted load and/or traffic during one or more subsequent time periods for one or more of the following: the one or more cells served by the first network node, the one or more cells served by the second network node, the one or more beams served by the first network node, and the one or more beams served by the second network node;
accuracy, precision, validity, reliability, stability, and/or likelihood associated with the predicted load and/or traffic;
measurements made by one or more user equipment, UEs, on one or more of the following: the one or more cells served by the first network node, the one or more cells served by the second network node, the one or more beams served by the first network node, and/or the one or more beams served by the second network node; and
current and/or predicted future radio-related conditions in the wireless network.

49. The method of claim 47, wherein the first message also includes one or more of the following:
an identifier associated with the predicted future adjustments;
an indication of accuracy, precision, validity, reliability, stability, and/or likelihood associated with the predicted future adjustments or with information used by the first network node to determine the predicted future adjustments;
an indication of load and/or traffic that is expected to be transferred from the first network node to the second network node after the predicted future adjustments are applied;
an indication of load and/or traffic that is expected to be transferred from the first network node to the second network node before the predicted future adjustments are applied; and
an indication of a validity time for the predicted future adjustments.

50. The method of claim 47, wherein the indication of the predicted future adjustments in the first message comprises one or more of the following indications:
that the predicted future adjustments will be applied by the first network node based on one or more first conditions;
that the predicted future adjustments will not be applied by the first network node based on one or more second conditions; and
that corresponding adjustments of mobility-related settings should be made by the second network node for mobility of users between the coverage area of the second network node and the adjacent coverage area of the first network node.

51. The method of claim 50, wherein when the first message indicates that corresponding adjustments of mobility-related settings should be made by the second network node, the second message also indicates one or more of the following:
confirmation or rejection of the corresponding adjustments indicated in the first message; and
the corresponding adjustments that should be made by the second network node, which are different than the corresponding adjustments indicated in the first message.

52. The method of claim 51, wherein one or more of the following applies:
when the second message includes a rejection of the predicted future adjustments indicated in the first message, the second message also includes a cause value indicating a reason why the predicted future adjustments are rejected by the second network node; and
when the second message includes a rejection of the corresponding adjustments indicated in the first message, the second message also includes a cause value indicating a reason why the corresponding adjustments are rejected by the second network node.

53. The method of claim 50, wherein:
the mobility-related settings for the first network node include a first mobility trigger point;
a coverage area of the first network node corresponds to a difference between a previous or current value of the first mobility trigger point and an adjusted value of the first mobility trigger point;
the one or more first conditions include any of the following:
load and/or load variation in the coverage area of the first network node being above, below, or between one or more first thresholds; and
a first time when or after which the predicted future adjustments will be applied, the first time being indicated in the first message, and
the one or more second conditions include any of the following:
load and/or load variation in the coverage area of the first network node being above, below, or between one or more second thresholds; and
a second time when or after which the predicted future adjustments have not been or will not be applied, the second time being indicated in the first message.

54. The method of claim 53, wherein:
the mobility-related settings for the second network node include a second mobility trigger point;
a coverage area of the second network node corresponds to a difference between a previous or current value of the second mobility trigger point and an adjusted value of the second mobility trigger point;
the corresponding adjustments of mobility-related settings, indicated in the second message, are based on one or more of the following third conditions:
load and/or load variation in the coverage area of the second network node being above, below, or between one or more third thresholds; and
the first time.

55. The method of claim 50, wherein the predicted future adjustments indicated in the first message and the corresponding adjustments indicated in the second message include at least one of the following:
adjustments to one or more of the following mobility-related settings: trigger points, hysteresis, time to trigger, and measurement offsets; and
adjustments specific to one or more of the following: one or more cells; one or more SSB beams; one or more CSI-RS beams; one or more network slices; one or more carrier frequencies; one or more services; one or more public land mobile networks, PLMNs; and one or more user equipment, UEs.

56. The method of claim 50, wherein the second message also includes one or more of the following:
an identifier associated with the corresponding adjustments;
one or more limitations at the second network node with respect to the predicted future adjustments of the first network node and/or the corresponding adjustments of the second network node indicated in the first message;
actual or estimated amount of traffic and/or load to be transferred from second network node to first network node after one or more of the following:
the predicted future adjustments indicated in the first message are applied by the first network node;
the corresponding adjustments indicated in the first message are applied by the second network node; and
the corresponding adjustments indicated in the second message are applied by the second network node.

57. A method for a second network node of a wireless network, the method comprising:
receiving, from a first network node of the wireless network, a first message comprising an indication of predicted future adjustments of mobility-related settings, of the first network node, for mobility of users between a coverage area of the first network node and an adjacent coverage area of the second network node; and
sending, to the first network node in response to the first message, a second message indicating one or more of the following:
acknowledgement, confirmation, or rejection of the predicted future adjustments; and
corresponding adjustments of mobility-related settings for the second network node.

58. The method of claim 57, further comprising determining the corresponding adjustments of mobility-related settings of the second network node, indicated in the second message, based on one or more of the following:
the predicted future adjustments of mobility-related settings of the first network node, indicated in the first message;
measured load and/or traffic during one or more current and/or previous time periods for one or more of the following: one or more cells served by the first network node, one or more cells served by the second network node, one or more beams served by the first network node, and one or more beams served by the second network node;
predicted load and/or traffic during one or more subsequent time periods for one or more of the following: the one or more cells served by the first network node, the one or more cells served by the second network node, the one or more beams served by the first network node, and the one or more beams served by the second network node;
accuracy, precision, validity, reliability, stability, and/or likelihood associated with the predicted load and/or traffic;
measurements made by one or more user equipment, UEs, on one or more of the following: the one or more cells served by the first network node, the one or more cells served by the second network node, the one or more beams served by the first network node, and the one or more beams served by the second network node; and
current and/or predicted future radio-related conditions in the wireless network.

59. The method of claim 57, wherein the first message also includes one or more of the following:
an identifier associated with the predicted future adjustments;
an indication of accuracy, precision, validity, reliability, stability, and/or likelihood associated with the predicted future adjustments or with information used by the first network node to determine the predicted future adjustments;
an indication of load and/or traffic that is expected to be transferred from the first network node to the second network node after the predicted future adjustments are applied;
an indication of load and/or traffic that is expected to be transferred from the first network node to the second network node before the predicted future adjustments are applied; and
an indication of a validity time for the predicted future adjustments.

60. The method of claim 57, wherein the indication of the predicted future adjustments in the first message comprises one or more of the following indications:
that the predicted future adjustments will be applied by the first network node based on one or more first conditions;
that the predicted future adjustments will not be applied by the first network node based on one or more second conditions; and
that corresponding adjustments of mobility-related settings should be made by the second network node for mobility of users between the coverage area of the second network node and the adjacent coverage area of the first network node.

61. The method of claim 60, wherein when the first message indicates that corresponding adjustments of mobility-related settings should be made by the second network node, the second message also indicates one or more of the following:
confirmation or rejection of the corresponding adjustments indicated in the first message; and
the corresponding adjustments that should be made by the second network node, which are different than the corresponding adjustments indicated in the first message.

62. The method of claim 61, wherein one or more of the following applies:
when the second message includes a rejection of the predicted future adjustments indicated in the first message, the second message also includes a cause value indicating a reason why the predicted future adjustments are rejected by the second network node; or
when the second message includes a rejection of the corresponding adjustments indicated in the first message, the second message also includes a cause value indicating a reason why the corresponding adjustments are rejected by the second network node.

63. The method of claim 60, wherein:
the mobility-related settings for the first network node include a first mobility trigger point;
a coverage area of the first network node corresponds to a difference between a previous or current value of the first mobility trigger point and an adjusted value of the first mobility trigger point;
the one or more first conditions include any of the following:
load and/or load variation in the coverage area of the first network node being above, below, or between one or more first thresholds; and
a first time when or after which the predicted future adjustments will be applied, the first time being indicated in the first message, and
the one or more second conditions include any of the following:
load and/or load variation in the coverage area of the first network node being above, below, or between one or more second thresholds; and
a second time when or after which the predicted future adjustments have not been or will not be applied, the second time being indicated in the first message.

64. The method of claim 63, wherein:
the mobility-related settings for the second network node include a second mobility trigger point;
a coverage area of the second network node corresponds to a difference between a previous or current value of the second mobility trigger point and an adjusted value of the second mobility trigger point;
the corresponding adjustments of mobility-related settings, indicated in the second message, are based on one or more of the following third conditions:
load and/or load variation in the coverage area of the second network node being above, below, or between one or more third thresholds; and
the first time.

65. The method of claim 60, wherein the predicted future adjustments indicated in the first message and the corresponding adjustments indicated in the second message include at least one of the following:
adjustments to one or more of the following mobility-related settings: trigger points, hysteresis, time to trigger, and measurement offsets; and
adjustments specific to one or more of the following: one or more cells; one or more SSB beams; one or more CSI-RS beams; one or more network slices; one or more carrier frequencies; one or more services; one or more public land mobile networks, PLMNs; and one or more user equipment, UEs.

66. The method of claim 60, wherein the second message also includes one or more of the following:
an identifier associated with the corresponding adjustments;
one or more limitations at the second network node with respect to the predicted future adjustments of the first network node and/or the corresponding adjustments of the second network node indicated in the first message;
actual or estimated amount of traffic and/or load to be transferred from second network node to first network node after one or more of the following:
the predicted future adjustments indicated in the first message are applied by the first network node;
the corresponding adjustments indicated in the first message are applied by the second network node; and
the corresponding adjustments indicated in the second message are applied by the second network node.

67. A first network node configured to operate in a wireless network, the first network node comprising:
communication interface circuitry configured to communicate with at least a second network node in the wireless network; and
processing circuitry operatively coupled to the communication interface circuitry, whereby the processing circuitry and the communication interface circuitry are configured to:
send, to the second network node, a first message comprising an indication of predicted future adjustments of mobility-related settings, of the first network node, for mobility of users between a coverage area of the first network node and an adjacent coverage area of the second network node; and
receive, from the second network node in response to the first message, a second message indicating one or more of the following:
acknowledgement, confirmation, or rejection of the predicted future adjustments; and
corresponding adjustments of mobility-related settings for the second network node.

68. A second network node configured to operate in a wireless network, the second network node comprising:
communication interface circuitry configured to communicate with at least a first network node in the wireless network; and
processing circuitry operatively coupled to the communication interface circuitry, whereby the processing circuitry and the communication interface circuitry are configured to perform the method of claim 57.
